(19) United States
(12) Patent Application Publication
(10) Pub. No.: US 2020/0257213 A1
(43) Pub. Date: Aug. 13, 2020

(54) ELECTROPHOTOGRAPHIC IMAGE FORMING METHOD

(71) Applicant: Konica Minolta, Inc., Tokyo (JP)

(72) Inventors: Tomoko Sakimura, Tokyo (JP); Hiroki Takao, Tokyo (JP); Mayuko Matsusaki, Tokyo (JP); Kengo Ikeda, Kitamoto-shi (JP)

(21) Appl. No.: 16/713,876

(22) Filed: Dec. 13, 2019

(30) Foreign Application Priority Data
Feb. 8, 2019 (JP) 2019-021788

(51) Int. Cl. G03G 7/00; G03G 15/02

(52) U.S. Cl. CPC G03G 7/0026; G03G 15/02

(57) ABSTRACT

Provide is an electrophotographic image forming method containing: a charging step, an exposure step, a developing step, a transfer step and a cleaning step by using a photoreceptor, wherein the charging step has a charging device for charging the surface of the photoreceptor; the photoreceptor has a protective layer, the protective layer contains a polymerized cured product of a composition containing a polymerizable monomer and an inorganic filler, a surface of the protective layer has a plurality of convex portions due to protrusion of the inorganic filler; in the developing step, a toner in which alumina particles are externally added to toner mother particles is used, and an average distance R between adjacent convex portions among the plurality of convex portions is set in the range of 100 to 250 nm.

### CROSS-REFERENCE TO RELATED APPLICATION

The entire disclosure of Japanese Patent Application No. 2019-021788, filed on Feb. 8, 2019 with Japan Patent Office, is incorporated herein by reference in its entirety.

### BACKGROUND

### 1. Technological Field

The present invention relates to an electrophotographic image forming method. In particular, the present invention relates to an electrophotographic image forming method which enables to suppress the toner charge fluctuation, to stabilize the image density in the formed image, to suppress the occurrence of fog, to achieve excellent dot reproducibility with reduced photoreceptor wear and blade wear, and to suppress the image defects.

### 2. Description of the Related Art

In the past, an external additive is added to the surface of toner mother particles in an electrostatic image developing toner (hereinafter also simply referred to as toner) from the viewpoint of improving chargeability and fluidity. As the external additive, inorganic oxide fine powder is generally used. Examples thereof include silica, titania, and alumina However, although silica particles are effective in improving fluidity, they have a high negative chargeability, and therefore tend to excessively increase the toner charge amount particularly in a low temperature and low humidity environment. In view of this, there is known a means for providing an effect of suppressing the charge amount in a low-temperature and low-humidity environment by using in combination with titania particles having a low electrical resistance (hereinafter also simply referred to as resistance). However, since titania particles have a low resistance, there is a problem that when the particles are transferred to carrier particles during high coverage printing, the charge transport of the carrier particles is promoted and the charge amount of the toner is reduced. Therefore, a method of increasing the amount of surface modification (treatment) of the titania particles may be mentioned in order to give the titania particles the same resistance as that of the carrier. However, the surface modification amount is excessive in order to adjust the resistance value of the titania particles to the same level as the carrier. When the surface modification amount is excessive, the cohesiveness of the external additive increases and the fluidity of the toner decreases, resulting in a decrease in charge amount. Therefore, by using alumina particles with higher resistance than titania particles, a technology that is capable of providing the same level of resistance as the carrier with an appropriate amount of surface modification and suppresses fluctuations in the charge amount when the carrier moves was proposed (for example, refer to Patent Document 1 (JP-A 2009-265471) and Patent Document 2 (JP-A 2009-192722).

### SUMMARY

The alumina particles have a specific gravity smaller than that of the titania particles and are attached in a state where they are easily released from the toner mother particles. In an electrophotographic image forming apparatus, after toner is developed on a photoreceptor and transferred to a recording medium, the toner remaining on the surface of the photoreceptor after transfer is removed by a cleaning member of the image forming apparatus. At this time, if the external additive is easily released from the toner, when the image with high coverage is continuously printed, the free external additive and its aggregates cause wear and scratches on the photoreceptor and the blade. As a result, cleaning failure may occur. In particular, since alumina has a high Mohs hardness, the photoreceptor and the blade are easily worn and scratched by the free alumina external additive.

The present invention has been made in view of the above problems and situations, and an object of the present invention is to provide an electrophotographic image forming method which enables to suppress the toner charge fluctuation, to stabilize the image density in the formed image, to suppress the occurrence of fog, to achieve excellent dot reproducibility with reduced photoreceptor wear and blade wear, and to suppress the image defects.

To achieve at least one of the above-mentioned objects according to the present invention, an electrophotographic image forming method that reflects an aspect of the present invention comprises a charging step, an exposure step, a development step, a transfer step and a cleaning step by using a photoreceptor, wherein the charging step has a charging device for charging the surface of the photoreceptor; the photoreceptor has a protective layer, the protective layer contains a polymerized cured product of a composition containing a polymerizable monomer and an inorganic filler, a surface of the protective layer has a plurality of convex portions due to protrusion of the inorganic filler; in the development step, a toner in which alumina particles are externally added to toner mother particles is used, and an average distance R between adjacent convex portions among the plurality of convex portions is in the range of 100 to 250 nm.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A is a photographic image obtained by photographing a convex structure of a protective layer according to the present invention with a raised inorganic filler using a scanning electron microscope.

FIG. 1B is a binarized image of the photographic image of FIG. 1A.

FIG. 2 is a schematic configuration diagram illustrating an example of a configuration of an electrophotographic image forming apparatus according to an embodiment of the present invention

FIG. 3 is a schematic configuration diagram illustrating an example of a non-contact charging unit and a lubricant supply unit provided in an electrophotographic image forming apparatus according to an embodiment of the present invention.

FIG. 4 is a schematic configuration diagram illustrating an example of a proximity charging type charging unit provided in an image forming apparatus according to another embodiment of the present invention.

FIG. 5 is a schematic configuration diagram illustrating an example of a manufacturing apparatus used for producing composite particles (core-shell particles).

### DETAILED DESCRIPTION OF THE EMBODIMENTS

Hereinafter, one or more embodiments of the present invention will be described by referring to the drawings. However, the scope of the invention is not limited to the disclosed embodiments. By the above embodiments of the present invention, it is possible to provide an electrophotographic image forming method which enables to suppress the toner charge fluctuation due to changes in the external environment and coverage, to stabilize the image density in the formed image, to suppress the occurrence of fog, to achieve excellent dot reproducibility with reduced photoreceptor wear and blade wear, and to suppress the image defects due to poor cleaning. The expression mechanism or action mechanism of the effect of the present invention is not clear, but it is presumed as follows. The distance between the convex portions of the inorganic filler varies depending on the amount of the inorganic filler added and the dispersibility of the inorganic filler. By dispersing the inorganic filler particles uniformly in the protective layer at a high concentration without agglomeration, the distance between the convex portions of the inorganic filler may be reduced. In the protective layer on the surface of the photoreceptor in the present invention, when the average distance R between the adjacent convex portions by the inorganic filler is 250 nm or less, the convex portions are uniformly dense, and when the toner comes into contact with the photoreceptor surface, the probability of touching the inorganic filler increases. In the resin portion and the inorganic filler portion on the surface of the photoreceptor, the inorganic filler portion is considered to have lower frictional force and adhesion with the toner, and the residual toner can be reliably and promptly removed during cleaning. In addition, when the average distance R between the adjacent convex portions is more than 250 nm, the toner can easily come into contact with the resin portion of the polymerized cured product, thereby increasing the adhesion force and the friction force between the toner and the protective layer. This increases the plunging force between the residual toner and the cleaning blade. Due to the increase in the plunging force, the liberation of the external additive is promoted, and an excessive free external additive and its aggregates are easily generated. As a result, the load at the time of cleaning increases, the amount of wear of the photoreceptor and the cleaning blade also increases, and it becomes difficult to obtain sufficient cleaning properties. When alumina particles are used as an external additive for the toner, the effect of suppressing fluctuations in the charge amount is high, but it is easily released from the toner base particles. Therefore, when the average distance R between the adjacent convex portions exceeds 250 nm, the release from the toner mother particles before the blade nip is particularly easily promoted. In addition, due to the high Mohs hardness, wear and scratches on the photoreceptor and the cleaning blade tend to be noticeable. In the protective layer of the photoreceptor of the present invention, residual toner is less likely to accumulate before the blade nip, and the release and aggregation of external additives due to convection of the residual toner before the blade nip are suppressed. Since slipping of free external additives and their aggregates is also reduced, even when alumina external additives are used, it is presumed that it is less likely to cause wear and scratches on the photoreceptor and cleaning blade, and associated cleaning defects. When the printing speed is increased, the linear velocity increases, so that the plunging force between the residual toner and the cleaning blade increases, and the contact pressure of the blade to the photosensitive member becomes difficult to stabilize. For this reason, the wear of the photoreceptor and the cleaning blade and the occurrence of image defects become more prominent. As a result, the present invention has the effect regardless of the printing speed, but has a particularly high effect when the printing speed is increased. In order to reduce the average distance R between the adjacent convex portions by the inorganic filler, it is effective to increase the inorganic filler concentration. However, when the inorganic filler concentration is too high, the polymerized and cured resin portion becomes relatively small, and the protective layer becomes brittle due to a decrease in the crosslinking density. As a result, photoreceptor wear increases. For the above reason, it is presumed that the average distance R between the adjacent convex portions by the inorganic filler needs to be 100 nm or more.

An electrophotographic image forming method of the present invention comprises a charging step, an exposure step, a developing step, a transfer step and a cleaning step by using a photoreceptor, wherein the charging step has a charging device for charging the surface of the photoreceptor; the photoreceptor has a protective layer, the protective layer contains a polymerized cured product of a composition containing a polymerizable monomer and an inorganic filler, a surface of the protective layer has a plurality of convex portions due to protrusion of the inorganic filler; in the developing step, a toner in which alumina particles are externally added to toner mother particles is used, and an average distance R between adjacent convex portions among the plurality of convex portions is in the range of 100 to 250 nm. This feature is a technical feature common to or corresponding to each of the following embodiments.

As an embodiment of the present invention, it is preferable that the inorganic filler is surface-modified with a surface modifier having a silicone chain in the side chain from the viewpoint of further reducing wear of the cleaning blade.

The number average primary particle size of the inorganic filler is preferably in the range of 50 to 200 nm from the viewpoint of further improving the cleaning properties and further reducing the wear of the photoreceptor and the cleaning blade.

When the number average particle diameter of the alumina particles is in the range of 10 to 60 nm, the fluidity of the toner is improved, and the toner and the carrier are sufficiently mixed when the toner is supplied to the developing machine. This is preferable in that a more stable charge amount transition may be obtained and the embedding of the external alumina additive in the toner mother material may be suppressed.

It is preferable that the inorganic filler has a polymerizable group from the viewpoint that the wear of the photoreceptor may be further reduced. Further, the inorganic filler is preferably a composite particle having a core-shell structure having an outer shell in which a metal oxide is attached to the surface of the core material. This is preferable in that the effect of reducing the wear of the photosensitive member and the cleaning blade and the effect of suppressing image defects may be further improved, and the transferability to the uneven paper may be further improved.

The present invention and the constitution elements thereof, as well as configurations and embodiments to carry out the present invention, will be detailed in the following. In the present description, when two figures are used to indicate a range of value before and after “to,” these figures are included in the range as a lowest limit value and an upper limit value.

### Outline of Electrophotographic Image Forming Method of the Present Invention

An electrophotographic image forming method of the present invention comprises a charging step, an exposure step, a developing step, a transfer step and a cleaning step by using a photoreceptor, wherein the charging step has a charging device for charging the surface of the photoreceptor; the photoreceptor has a protective layer, the protective layer contains a polymerized cured product of a composition containing a polymerizable monomer and an inorganic filler, a surface of the protective layer has a plurality of convex portions due to protrusion of the inorganic filler; in the developing step, a toner in which alumina particles are externally added to toner mother particles is used, and an average distance R between the adjacent convex portions among the plurality of convex portions is in the range of 100 to 250 nm.

The surface of the protective layer has a convex structure due to the protrusion of the inorganic filler. In the present specification, the “convex structure by the protrusion of the inorganic filler” means a convex structure formed by the exposed inorganic filler. The confirmation of the convex structure present on the surface of the protective layer due to the protrusion of the inorganic filler may be done by visually observing the photographic image of the surface of the protective layer taken using a scanning electron microscope (SEM) “JSM-7401F” (manufactured by JEOL Ltd.).

### Average Distance R Between Convex Portions

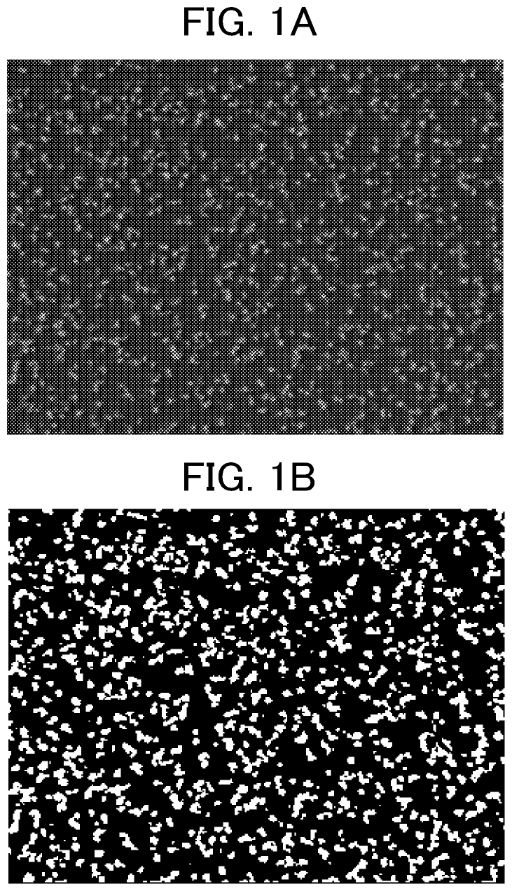

The average distance R between the convex portions of the convex structure due to the protrusion of the inorganic filler in the protective layer (hereinafter also referred to as “average distance R between convex portions”) is calculated as follows. First, the outermost protective layer is photographed (magnification: 10000 times, acceleration voltage: 2 kV) with a scanning electron microscope “JSM-7401F” (manufactured by JEOL Ltd.) (see FIG. 1A). The photographed image is taken in an image processing analysis device LUZEX AP (manufactured by Nireco Corporation) with an automatic image processing analysis system LUZEX (registered trademark) AP Software Ver. 1.32 (manufactured by Nireco Co., Ltd.), and the photographic image data is binarized using the maximum value +30 level of the monochrome histogram as a threshold (see FIG. 1B). The distance between adjacent centroids is calculated, and this is defined as the average distance R between the convex portions of the convex structure formed by the protrusion of the inorganic filler in the protective layer.

The average distance R between the convex portions according to the present invention is in the range of 100 to 250 nm as described above. The lower limit is preferably 120 nm or more. The upper limit is preferably 240 nm or less, more preferably 225 nm or less, and still more preferably 200 nm or less. By setting the average distance R between the convex portions to 250 nm or less, the protrusions are uniformly dense, and the probability that the toner contacts the inorganic filler portion when the toner contacts the surface of the photoreceptor increases. As a result, residual toner may be reliably and promptly removed during cleaning. In addition, the residual toner is less likely to accumulate before the blade nip, and the liberation and aggregation of the external additive due to the convection of the residual toner before the blade nip is suppressed, and the slipping of the free external additive and its aggregate is reduced. For this reason, even when an external additive of alumina is used, wear and scratches on the photosensitive member and the cleaning blade, and associated cleaning defects are less likely to occur. In order to reduce the average distance R between the convex portions by the inorganic filler, it is effective to increase the inorganic filler concentration. However, when the concentration of the inorganic filler is too high, the polymerized and cured resin portion is relatively reduced, so that the crosslink density is lowered, the protective layer becomes brittle, and the photoreceptor wear increases. For this reason, it is presumed that the average distance R between the convex portions due to the inorganic filler needs to be 100 nm or more.

The average height H (hereinafter also referred to as “convex average height”) of the protrusion is not particularly limited, but it is preferably 1 nm or more, more preferably 15 nm or more, and still more preferably 25 nm or more. Within this range, the cleaning properties are further improved and the wear of the photoreceptor is further reduced. This is presumably because the average height of the convex portion of the protective layer is increased, the wear of the protective layer by the cleaning blade is further reduced, and the possibility of contact between the toner and the protective layer due to contact between the external additive and the inorganic filler is further increased. The average height of the convex portions is not particularly limited, but it is preferably 100 nm or less, more preferably 55 nm or less, and still more preferably 35 nm or less (lower limit 0 nm). Within this range, the cleaning property is further improved and the wear of the cleaning blade is further reduced. This is presumably because the wear of the cleaning blade due to the inorganic filler in the protective layer is further reduced, and contact between the cleaning blade and the resin portion of the polymerized cured product constituting the protective layer occurs sufficiently.

The average height of the convex portion may be calculated by the following method. Three-dimensional roughness analysis Scanning electron microscope “ERA-600FE” (manufactured by Elionix, Inc.) is used to measure the surface of the outermost layer three-dimensionally, and in three-dimensional analysis, the average height of contour curve elements is calculated. The value is defined as the average height of the convex portions of the protective layer.

Here, the average distance R between the convex portions and the average height H of the convex portions may be controlled by the type, the particle size, and the content of the inorganic filler. Further, by uniformly dispersing the inorganic filler in the protective layer without agglomerating, the average distance R between the convex portions may be controlled to an optimum range. As will be described later, the inorganic filler may be uniformly dispersed in the protective layer by optimizing the particle size of the inorganic filler, and the presence/absence or the type of the surface modifier.

### Electrophotographic Photoreceptor

In the electrophotographic image forming method of the present invention, a photoreceptor (electrophotographic photoreceptor) is used.

An electrophotographic photoreceptor is an object that carries a latent image or a visible image on its surface in an electrophotographic image forming method.

The photoreceptor is not particularly limited. A preferable example of the photoreceptor contains a conductive support, a photosensitive layer disposed on the conductive support, and a protective layer disposed on the photosensitive layer as an outermost layer. In addition, the photoreceptor may further include a configuration other than the conductive support, the photosensitive layer, and the protective layer. A preferable example of the other configurations includes an intermediate layer. The intermediate layer is, for example, a layer having a barrier function and an adhesive function that is disposed between the conductive support and the photosensitive layer. As an example of a preferable embodiment of the photoreceptor used in the present invention, a photoreceptor having a composition of a conductive support, an intermediate layer disposed on the conductive support, a photosensitive layer disposed on the intermediate layer, and a protective layer disposed on the photosensitive layer as an outermost layer is mentioned.

Hereinafter, the electrophotographic photoreceptor having such a configuration will be described in detail.

### Conductive Support

A conductive support is a member that is capable of supporting the photosensitive layer, and has an electric conductivity. Examples of the conductive support are: a metal drum or sheet, a plastic film having a laminated metal foil, a plastic film having a film of a vapor deposited conductive material, a metal member or a plastic film having a conductive layer formed by coating a paint composed of a conductive substance or a conductive substance with a binder resin, and a paper. Examples of the metal are: aluminum, copper, chromium, nickel, zinc, and stainless steel. Preferable examples of the conductive substance are: the above-described metals, indium oxide, and tin oxide.

### Photosensitive Layer

A photosensitive layer is a layer for forming an electrostatic latent image of a required image by light exposure described later on a photoreceptor. The photosensitive layer may be composed of a single layer, or may be formed by laminating a plurality of layers. For examples, a single layer constitution that contains a charge transport material and a charge generation material; and a laminate constitution composed of a charge transport layer containing a charge transport material and a charge generation layer containing a charge generation material are cited.

### Protective Layer

The protective layer is preferably a layer disposed on the outermost side on the side in contact with the toner, and it is a layer for improving the mechanical strength of the surface of the photoreceptor and improving scratch resistance and abrasion resistance. The protective layer according to the present invention contains a polymerized and cured product of a composition containing a polymerizable monomer and an inorganic filler (hereinafter also referred to as a protective layer forming composition).

### Inorganic Filler

The composition for forming the protective layer contains an inorganic filler. In the present specification, an inorganic filler means the particles in which at least the surface of the particle is composed of an inorganic substance. The inorganic filler has a function of improving the wear resistance of the protective layer. Further, it has a function of improving the removability of the residual toner to improve the cleaning property and reducing the wear of the photoreceptor and the cleaning blade.

Hereinafter, the surface modifier having a silicone chain is also simply referred to as a “silicone surface modifier,” and the surface modification by the “silicone surface modifier” is also simply referred to as “silicone surface modification.”

Further, the surface modifier having a polymerizable group is also simply referred to as a “reactive surface modifier,” and the surface modification by the “reactive surface modifier” is also simply referred to as “reactive surface modification.”

Further, the inorganic filler to which at least one of “silicone surface modification” and “reactive surface modification” is applied may be simply referred to as “surface-modified particles.”

The inorganic filler is not particularly limited, but preferably it contains metal oxide particles. In this specification, the metal oxide particles are particles in which at least the surface (in the case of surface-modified particles, the surface of unmodified metal oxide particles that are unmodified mother particles) is composed of a metal oxide.

The shape of the particles is not particularly limited, and it may be any shape such as powder, sphere, rod, needle, plate, column, indefinite shape, flake shape, and spindle shape.

Examples of the metal oxide constituting the metal oxide particles are not particularly limited. Specific examples of the metal oxide include silica (silicon oxide), magnesium oxide, zinc oxide, lead oxide, alumina (aluminum oxide), tin oxide, tantalum oxide, indium oxide, bismuth oxide, yttrium oxide, cobalt oxide, copper oxide, manganese oxide, selenium oxide, iron oxide, zirconium oxide, germanium oxide, titanium dioxide, niobium oxide, molybdenum oxide, vanadium oxide and copper aluminum oxide, and antimony-doped tin oxide. Among these, silica (SiO₂) particles, tin oxide (SnO₂) particles, titanium dioxide (TiO₂) particles, and antimony-doped tin oxide (SnO₂—Sb) particles are preferable, and tin oxide particles are more preferable. These metal oxide particles may be used alone or in combination of two or more.

The metal oxide particles are preferably core-shell composite particles having a core material (core) and an outer shell (shell) made of a metal oxide. When using such particles, by selecting a core material (core) having a small difference in refractive index from the polymerizable monomer, the permeability of active energy rays (particularly ultraviolet rays) used for curing the protective layer is improved, the film strength of the protective layer after curing is improved, and the wear of the protective layer is further reduced. In addition, by selecting the material constituting the outer shell (shell) and controlling the shape of the outer shell (shell), the surface modification effect in the surface-modified particles described later may be further enhanced. As a result, it is possible to further improve the effect of reducing the wear of the photoreceptor and the cleaning blade and the effect of suppressing image defects, and further improve the transferability to the uneven paper. Although the material which constitutes the core material (core) of the composite particle is not limited in particular, insulating materials such as barium sulfate (BaSO₄), an alumina (Al₂O₃), and a silica (SiO₂) may be mentioned. Among these, barium sulfate and silica are preferable from the viewpoint of ensuring the light transmittance of the protective layer. Moreover, the material which constitutes the outer shell (shell) of the composite particle is the same as what was mentioned as a metal oxide which constitutes the metal oxide particle. Preferable examples of the core-shell composite particles include core-shell composite particles having a core material made of barium sulfate and an outer shell made of tin oxide. The ratio between the number average primary particle size of the core material and the thickness of the outer shell is appropriately determined so as to obtain a desired surface modification effect depending on the type of the core material and outer shell used, and combinations thereof.

The lower limit of the number average primary particle size of the inorganic filler is not particularly limited, but it is preferably 1 nm or more, more preferably 5 nm or more, still more preferably 10 nm or more, and further preferably 50 nm or more. 80 nm or more is particularly preferable. Within this range, the cleaning properties are further improved and the wear of the photoreceptor is further reduced. The upper limit of the number average primary particle size of the inorganic filler is not particularly limited, but it is preferably 700 nm or less, more preferably 500 nm or less, still more preferably 300 nm or less, and further preferably 200 nm or less. Particularly preferred is 150 nm or less. Within this range, the cleaning property is further improved and the wear of the cleaning blade is further reduced. The reason of this assumed as follows. By controlling the number average primary particle size to the above range, it is possible to control the average distance R between the convex portions of the convex structure due to the protrusion of the inorganic filler of the protective layer to the optimum range. Thus, as an example of a preferred embodiment of the present invention, the number average primary particle size of the inorganic filler is in the range of 50 to 200 nm.

In the present specification, the number average primary particle size of the inorganic filler is measured by the following method. First, about a protective layer, the 10,000 times enlarged photograph image photographed with a scanning electron microscope (made by JEOL Ltd.) is taken into a scanner. Next, from the obtained photographic images, 300 particle images excluding the agglomerated particles are randomly selected, and binarization is performed using an automatic image processing analysis system LUZEX (registered trademark) AP Software Ver. 1.32 (manufactured by Nireco Corporation). Then, the horizontal ferret diameter of each particle image is calculated. And the average value of the horizontal direction ferret diameter of the said particle image is calculated, and it is determined as a number average primary particle diameter. Here, the horizontal ferret diameter means the length of a side parallel to the x-axis of the circumscribed rectangle when the particle image is binarized. In addition, the number average primary particle size of the inorganic filler is measured for an inorganic filler (untreated mother particle) that does not contain a chemical species having a polymerizable group or a chemical species derived from a surface modifier (coating layer) in the case of the inorganic filler having a polymerizable group and surface-modified particles to be described later.

The inorganic filler in the protective layer-forming composition preferably has a polymerizable group. When the inorganic filler in the composition for forming a protective layer has a polymerizable group, the wear of the photoreceptor is further reduced. This is presumed to be because the inorganic filler having a polymerizable group and the polymerizable monomer are chemically bonded in the cured product constituting the protective layer, and the film strength of the protective layer is improved. The type of the polymerizable group is not particularly limited, but a radical polymerizable group is preferable. The method for introducing a polymerizable group is not particularly limited, but as described later, a method of performing surface modification with a surface modifier having a polymerizable group on an inorganic filler is preferable.

The fact that the inorganic filler in the protective layer-forming composition has a polymerizable group, or the fact that the inorganic filler in the protective layer has a group derived from a polymerizable group may be confirmed by thermogravimetric/differential heat (TG/DTA) measurement, observation by scanning electron microscope (SEM) or transmission electron microscope (TEM), and analysis by energy dispersive X-ray spectroscopy (EDX).

The preferable content of the inorganic filler in the composition for forming a protective layer is described in the description of the method for producing an electrophotographic photoreceptor described later. The inorganic filler is preferably hydrophobized with a surface treatment agent (surface modifier). By performing the hydrophobization treatment, the inorganic filler may be uniformly dispersed in the protective layer at a high concentration and without being aggregated, and the average distance R between the convex portions may be controlled to an optimum range. As the hydrophobic surface treatment agent, for example, a general coupling agent, a silane compound, or a surface treatment agent having a silicone chain (silicone surface treatment agent, silicone surface modifier) may be used.

### Surface Modification (Surface Treatment) With a Surface Modifier Having a Silicone Chain

The inorganic filler is preferably surface-modified with a silicone surface modifier.

The silicone surface modifier preferably has a structural unit represented by the following Formula (1).

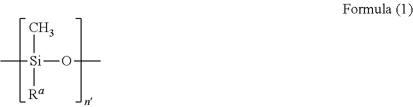

In Formula (1), R^{a} represents a hydrogen atom or a methyl group, and n′ represents an integer of 3 or more.

The silicone surface modifier may be a silicone surface modifier with a silicone chain in the main chain (main chain type silicone modifier) or a silicone surface modifier with a silicone chain in the side chain (side chain type silicone modifier). However, a side chain type silicone modifier is preferred. That is, the inorganic filler is preferably surface-modified with a side chain type silicone surface modifier. The side chain type silicone modifier further reduces the adhesion and frictional force between the external additive and the inorganic filler, and further improves the removability of the residual toner, thereby further improving the cleaning property. It has a function of further reducing blade wear in particular. The reason is estimated as follows. The side chain type silicone surface modifier has a bulky structure, it increases the concentration of the silicone chain on the inorganic filler, and efficiently hydrophobizes the surface of the metal oxide particles. As a result, the adhesive force and frictional force between the external additive and the inorganic filler may be significantly reduced.

The side chain type silicone surface modifier is not particularly limited. Those having a silicone chain in the side chain of the polymer main chain and further having a surface-modifying functional group are preferred. Examples of the surface modification functional group include groups capable of binding to conductive metal oxide particles such as a carboxylic acid group, a hydroxy group, -Rd-COOH (Rd is a divalent hydrocarbon group), a halogenated silyl group, and an alkoxysilyl group. Among these, a carboxylic acid group, a hydroxy group or an alkoxysilyl group is preferable, and a hydroxy group or an alkoxysilyl group is more preferable.

The side chain type silicone surface modifier preferably has a poly(meth)acrylate main chain or a silicone main chain as a polymer main chain from the viewpoint of further reducing the wear of the cleaning blade while maintaining the effects of the present invention.

The silicone chain of the side chain or the main chain preferably has a dimethylsiloxane structure as a repeating unit, and the number of repeating units is preferably 3 to 100, more preferably 3 to 50.

The weight average molecular weight of the silicone surface modifier is not particularly limited, but is preferably in the range of 1000 to 50000. The weight average molecular weight of the silicone surface modifier can be measured by gel permeation chromatography (GPC).

The silicone surface modifier may be a synthetic product or a commercially available product. Specific examples of commercially available main chain type silicone surface modifiers include KF-99 and KF-9901 (manufactured by Shin-Etsu Chemical Co., Ltd.). Moreover, as a specific example of a commercially available product of a side-chain type silicone surface modifier having a silicone chain in the side chain of the poly(meth)acrylate main chain, Saimak (registered trademark) US-350 (manufactured by Toagosei Co., Ltd.)), KP-541, KP-574, and KP-578 (manufactured by Shin-Etsu Chemical Co., Ltd.) are mentioned. Specific examples of the commercially available side chain type silicone surface modifier having a silicone chain in the side chain of the silicone main chain include KF-9908 and KF-9909 (manufactured by Shin-Etsu Chemical Co., Ltd.). The silicone surface modifiers may be used alone or in combination of two or more.

The surface modification method using the silicone surface modifier is not particularly limited as long as the method is capable of attaching (or bonding) the silicone surface modifier on the surface of the inorganic filler. In general, such methods are roughly classified into a wet processing method and a dry processing method, and any of them may be used.

When the inorganic filler treated with the reactive surface modification described later is used for silicone surface modification, the surface modification method using the silicone surface modifier is only required to allow the silicone surface modifier to adhere (or bind) on the surface of the inorganic filler or on the reactive surface modifier.

The wet processing method is a method in which an inorganic filler and a silicone surface modifier are dispersed in a solvent to adhere (or bond) the silicone surface modifier on the surface of the inorganic filler. As this method, preferable is a method in which an inorganic filler and a silicone surface modifier are dispersed in a solvent, and the obtained dispersion is dried to remove the solvent. A method in which the silicone surface modifier is adhered (or bonded) on the surface of the inorganic filler by further performing a heat treatment and reacting the silicone surface modifier with the inorganic filler is more preferable. Further, after the silicone surface modifier and the inorganic filler are dispersed in a solvent, the resulting dispersion may be wet pulverized to refine the inorganic filler and simultaneously proceed with the surface modification.

The means for dispersing the inorganic filler and the silicone surface modifier in the solvent is not particularly limited, and known means may be used. Examples thereof include general dispersing means such as a homogenizer, a ball mill, and a sand mill.

The solvent is not particularly limited, and a known solvent may be used. Preferred examples thereof include alcohol solvents such as methanol, ethanol, n-propanol, isopropanol, n-butanol, sec-butanol (2-butanol), tert-butanol, and benzyl alcohol; and aromatic hydrocarbon solvents such as toluene and xylene. These may be used alone or in combination of two or more.

The method for removing the solvent is not particularly limited, and a known method may be used. Examples thereof include a method using an evaporator and a method of volatilizing the solvent at room temperature. Among these, the method of volatilizing the solvent at room temperature is preferable.

The heating temperature is not particularly limited, and it is preferably in the range of 50 to 250° C., more preferably in the range of 70 to 200° C., and still more preferably in the range of 80 to 150° C. The heating time is not particularly limited, but it is preferably in the range of 1 to 600 minutes, more preferably in the range of 10 to 300 minutes, and still more preferably in the range of 30 to 90 minutes. The heating method is not particularly limited, and a known method may be used.

The dry processing method is a method of adhering (or bonding) the silicone surface modifier on the surface of the inorganic filler by mixing and kneading the silicone surface modifier and the inorganic filler without using a solvent. The dry method may be a method in which a silicone surface modifier and an inorganic filler are mixed and kneaded, and then further subjected to a heat treatment to react the silicone surface modifier with the inorganic filler, thereby bringing the silicone surface modifier into the surface of the inorganic filler, and attaching (or bonding) on the surface. Further, when the inorganic filler and the silicone surface modifier are mixed and kneaded, they may be dry pulverized to refine the inorganic filler and simultaneously proceed with the surface modification.

The amount of the silicone surface modifier used is preferably 0.1 mass parts or more, more preferably 1 mass part or more, and still more preferably 2 mass parts or more with respect to 100 mass parts of the inorganic filler before the silicone surface modification (when the inorganic filler after the reactive surface modification described below is silicone surface modified, the inorganic filler after the reactive surface modification). Within this range, cleaning property will be improved more and abrasion of a cleaning blade will be reduced more. The amount of the silicone surface modifier used is preferably 100 mass parts or less, more preferably 10 mass part or less, and still more preferably 5 mass parts or less with respect to 100 mass parts of the inorganic filler before the silicone surface modification (when the inorganic filler after the reactive surface modification described below is silicone surface modified, the inorganic filler after the reactive surface modification). Within this range, a decrease in the film strength of the protective layer due to the unreacted silicone surface modifier is suppressed, and the wear of the photoreceptor is further reduced.

The fact that silicone surface modification was applied to unmodified inorganic fillers and inorganic fillers after reactive surface modification may be determined by thermogravimetric/differential heat (TG/DTA) measurement, observation by scanning electron microscope (SEM) or transmission electron microscope (TEM), and analysis by energy dispersive X-ray spectroscopy (EDX).

### Surface Modification Method Using a Surface Modifying Agent Having a Polymerizable Group (Reactive Surface Modifying Agent)

As described above, the inorganic filler in the protective layer-forming composition preferably has a polymerizable group. The method for introducing the polymerizable group is not particularly limited, but a method of performing reactive surface modification is preferable.

That is, the inorganic filler is preferably surface-modified (reactive surface modification) with a surface modifying agent having a polymerizable group (reactive surface modifying agent). The polymerizable group is supported on the surface of the conductive metal oxide particle by reactive surface modification, and as a result, the inorganic filler has a polymerizable group. In addition, since the inorganic filler exists as a structure having a group derived from a polymerizable group in the protective layer, the inorganic filler having a group derived from a polymerizable group is mentioned as an example of a preferred embodiment of the present invention.

The reactive surface modifier has a polymerizable group and a surface modifying functional group. The type of the polymerizable group is not particularly limited, but a radical polymerizable group is preferable. Here, the radical polymerizable group represents a radical polymerizable group having a carbon-carbon double bond. Examples of the radical polymerizable group include a vinyl group and a (meth)acryloyl group. Among these, a methacryloyl group is preferable. The surface-modifying functional group represents a group having reactivity with a polar group such as a hydroxy group present on the surface of the conductive metal oxide particle. Examples of the surface-modifying functional group include a carboxy group, a hydroxy group, —R^{d′}—COOH (R^{d′} is a divalent hydrocarbon group), a halogenated silyl group, and an alkoxysilyl group. Among these, a halogenated silyl group and an alkoxysilyl group are preferred.

The reactive surface modifier is preferably a silane coupling agent having a radical polymerizable group, and examples thereof include compounds represented by the following formulas S-1 to S-21.

S-1: CH₂═CHSi(CH₃)(OCH₃)₂
S-2: CH₂═CHSi(OCH₃)₃
S-3: CH₂═CHSi(OC₂H₅)₃
S-4: CH₂═CHCH₂Si(OCH₃)₃
S-5: CH₂═CHCH₂Si(OC₂H₅)₃
S-6: CH₂═CHCOO(CH₂)₂Si(CH₃)(OCH₃)₂
S-7: CH₂═CHCOO(CH₂)₂Si(OCH₃)₃
S-8: CH₂═CHCOO(CH₂)₃Si(OCH₃)₃
S-9: CH₂═CHCOO(CH₂)₃Si(OC₂H₅)₃
S-10: CH₂═CHCOO(CH₂)₃Si(CH₃)(OCH₃)₂
S-11: CH₂═CHCOO(CH₂)₃SiCl₃
S-12: CH₂═CHCOO(CH₂)₃Si(CH₃)Cl₂
S-13: CH₂═C(CH₃)COO(CH₂)₂Si(CH₃)(OCH₃)₂
S-14: CH₂═C(CH₃)COO(CH₂)₂Si(OCH₃)₃
S-15: CH₂═C(CH₃)COO(CH₂)₃Si(CH₃)(OCH₃)₂
S-16: CH₂═C(CH₃)COO(CH₂)₃Si(OCH₃)₃
S-17: CH₂═C(CH₃)COO(CH₂)₃Si(OC₂H₅)₃
S-18: CH₂═C(CH₃)COO(CH₂)₃Si(CH₃)Cl₂
S-19: CH₂═C(CH₃)COO(CH₂)₃SiCl₃
S-20: CH₂═C(CH₃)COO(CH₂)₈Si(OCH₃)₃

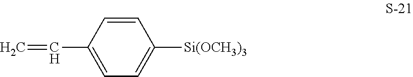

The reactive surface modifier may be a synthetic product or a commercially available product. Specific examples of the commercially available product include KBM-502, KBM-503, KBE-502, KBE-503, and KBM-5103 (manufactured by Shin-Etsu Chemical Co., Ltd.). Moreover, a reactive surface modifier may be used alone or in combination of 2 or more types.

When both the silicone surface modification and the reactive surface modification are performed, it is preferable to perform the silicone surface modification after the reactive surface modification. By performing the surface modification in this order, the wear resistance of the protective layer is further improved. This is because the silicone chain having an oil repellent effect does not prevent the reactive surface modifier from contacting the surface of the inorganic filler, so that the introduction of the polymerizable group into the inorganic filler is more efficiently performed.

The method for the reactive surface modification is not particularly limited, and the same method as described for the silicone surface modification can be adopted except that a reactive surface modifier is used. Moreover, the surface modification technique of a well-known metal oxide particle may be used.

Here, when using the wet processing method, the same solvent as the method described in the silicone surface modification may be preferably used.

The amount of the reactive surface modifier used is preferably 0.5 mass parts or more, more preferably 1 mass part or more, and still more preferably 1.5 mass parts or more with respect to 100 mass parts of the inorganic filler before the reactive surface modification (in the case of reactive surface modification of the inorganic filler after silicone surface modification, the inorganic filler after silicone surface modification). Within this range, the film strength of the protective layer is improved and the wear of the photoreceptor is further reduced. The amount of the reactive surface modifier used is preferably 15 mass parts or less, more preferably 10 mass parts or more, and still more preferably 8 mass parts or more with respect to 100 mass parts of the inorganic filler before the reactive surface modification (in the case of reactive surface modification of the inorganic filler after silicone surface modification, the inorganic filler after silicone surface modification). When the amount is within this range, the amount of the reactive surface modifier is not excessive with respect to the number of hydroxy groups on the particle surface, and becomes a more appropriate range. The decrease in the film strength of the protective layer due to the unreacted reactive surface modifier is suppressed, the film strength of the protective layer is improved, and the wear of the photoreceptor is further reduced.

### Polymerizable Monomer

The composition for forming a protective layer contains a polymerizable monomer. In the present specification, the polymerizable monomer represents a compound having a polymerizable group, and is polymerized (cured) by irradiation with active energy rays such as ultraviolet rays, visible rays, and electron beams, or by addition of energy such as heating. The compound is used as the binder resin of a protective layer. The polymerizable monomer in the present specification does not include the above-described reactive surface modifier, and when a polymerizable silicone compound or a polymerizable perfluoropolyether compound as a lubricant described later is used, they are not included in the polymerizable monomer.

The kind of the polymerizable group possessed by the polymerizable monomer is not particularly limited, but a radical polymerizable group is preferable. Here, the radical polymerizable group represents a radical polymerizable group having a carbon-carbon double bond. Examples of the radical polymerizable group include a vinyl group and a (meth)acryloyl group, and a (meth)acryloyl group is preferable. When the polymerizable group is a (meth)acryloyl group, the wear resistance of the protective layer is improved and the wear of the photoreceptor is further reduced. The reason for the improvement of the abrasion resistance of the protective layer is presumed to be that it may be efficiently cured with a small amount of light or in a short time.

Examples of the polymerizable monomers include styrene monomers, (meth)acrylic monomers, vinyl toluene monomers, vinyl acetate monomers, and N-vinyl pyrrolidone monomers. These polymerizable monomers may be used alone or in admixture of two or more.

The number of polymerizable groups in one molecule of the polymerizable monomer is not particularly limited, but it is preferably 2 or more, and more preferably 3 or more. Within this range, the wear resistance of the protective layer is improved and the wear of the photoreceptor is further reduced. The reason for this is presumed to be that the crosslink density of the protective layer increases and the film strength is further improved. The number of polymerizable groups in one molecule of the polymerizable monomer is not particularly limited, but it is preferably 6 or less, more preferably 5 or less, and still more preferably 4 or less. Within this range, the uniformity of the protective layer increases. The reason for this is presumed to be that the crosslink density is below a certain level and curing shrinkage hardly occurs. From these viewpoints, the number of polymerizable groups in one molecule of the polymerizable monomer is most preferably 3.

Specific examples of a polymerizable monomer include the following compounds M1 to M11, but the present invention is not limited to them. Among these, compound M2 is particularly preferable. In the following structures, R represents an acryloyl group (CH₂═CHCO—), and R′ represents a methacryloyl group (CH₂═C(CH₃)CO—).

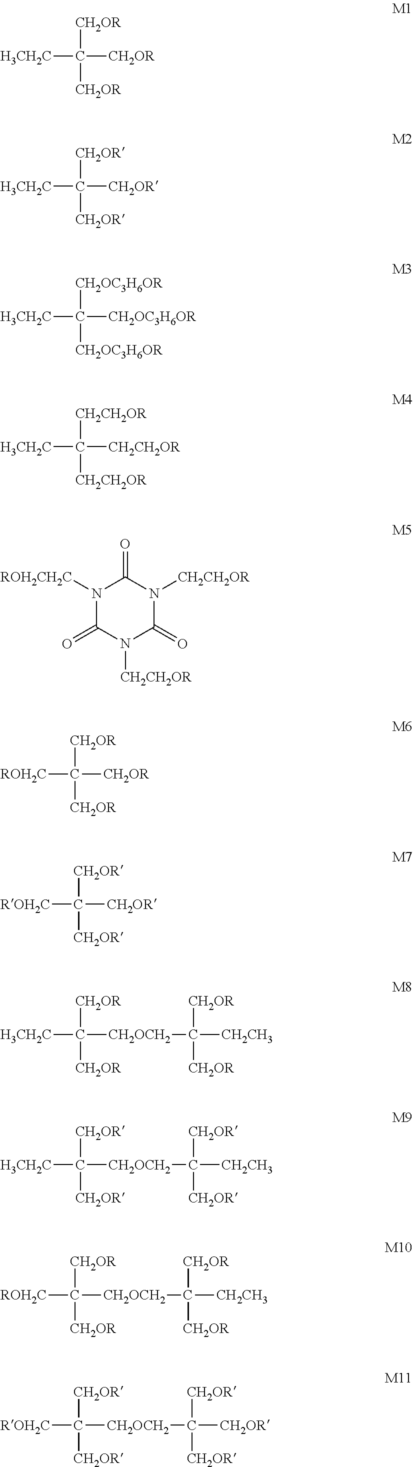

The above-described polymerizable monomers may be synthesized by a known method, and they may be obtained as a commercially available product. The polymerizable monomers may be used alone or in combination of two or more.

The preferable content of the polymerizable monomer in the composition for forming a protective layer is described in the description of the method for producing an electrophotographic photoreceptor described later.

### Polymerization Initiator

The protective layer-forming composition preferably further contains a polymerization initiator. The polymerization initiator is used in the process of producing a cured resin (binder resin) obtained by polymerizing the polymerizable monomer. The polymerization initiator may be a thermal polymerization initiator or a photopolymerization initiator, but it is preferably a photopolymerization initiator. Moreover, when a polymerizable monomer is a radically polymerizable monomer, it is preferable that it is a radical polymerization initiator. The radical polymerization initiator is not particularly limited, and known ones can be used. Examples thereof include alkylphenone compounds and phosphine oxide compounds. Among these, a compound having an α-aminoalkylphenone structure or an acylphosphine oxide structure is preferable, and a compound having an acylphosphine oxide structure is more preferable. An example of the compound having an acylphosphine oxide structure is IRGACURE (registered trademark) 819 (bis (2,4,6-trimethylbenzoyl)phenylphosphine oxide) (manufactured by BASF Japan Ltd.).

The polymerization initiators may be used alone or in combination of two or more.

The preferable content of the polymerization initiator in the composition for forming a protective layer is described in the description of the method for producing an electrophotographic photoreceptor described later.

### Other Components

The composition for protective layer formation may further contain other components other than the above-described component. Examples of the other components include, but are not limited to, a lubricant and a charge transport material. The charge transport material is not particularly limited, and known materials may be used. Examples thereof include triarylamine derivatives. The lubricant is not particularly limited and a known one may be used. Examples thereof include a polymerizable silicone compound and a polymerizable perfluoropolyether compound.

### Protective Layer Thickness

The thickness of the protective layer may be appropriately set according to the type of the photoreceptor, and it is not particularly limited. However, for a general photoreceptor, the thickness is preferably in the range of 0.2 to 15 μm. More preferably, it is in the range of 0.5 to 10 μm.

### Method for Producing Electrophotographic Photoreceptor

The electrophotographic photoreceptor used in one embodiment of the present invention is not particularly limited except that a coating liquid for forming a protective layer described later is used, and it may be produced by a known method for producing an electrophotographic photoreceptor. Among these, it is preferably produced by a method comprising the steps of: applying a protective layer-forming coating solution on the surface of the photosensitive layer formed on the conductive support; and irradiating the applied protective layer-forming coating solution with active energy rays, or heating the applied protective layer forming coating solution and polymerizing the polymerizable monomer in the protective layer forming coating solution. A method comprising: applying a protective layer-forming coating solution; and irradiating the applied protective layer-forming coating solution with active energy rays to polymerize a polymerizable monomer in the protective layer-forming coating solution is more preferable.

The coating liquid for forming a protective layer contains a composition for forming a protective layer containing a polymerizable monomer and an inorganic filler. The protective layer-forming composition preferably further contains a polymerization initiator, and may further contain other components than these components. Moreover, it is preferable that the coating liquid for protective layer formation contains the composition for protective layer formation, and a dispersion medium. In the present specification, the protective layer forming composition does not include a compound used only as a dispersion medium.

The dispersion medium is not particularly limited and known ones may be used. Examples thereof include methanol, ethanol, n-propyl alcohol, isopropyl alcohol, n-butanol, tert-butanol, 2-butanol (sec-butanol). Benzyl alcohol, toluene, xylene, methyl ethyl ketone, cyclohexane, ethyl acetate, butyl acetate, methyl cellosolve, ethyl cellosolve, tetrahydrofuran, 1,3-dioxane, 1,3-dioxolane, pyridine and diethylamine. A dispersion medium may be used alone or may be used in combination of 2 or more types.

The content of the dispersion medium with respect to the total mass of the coating liquid for forming the protective layer is not particularly limited, but it is preferably in the range of 1 to 99 mass %, and more preferably in the range of 40 to 90 mass % And still more preferably it is in the range of 50 to 80 mass %.

Although the content of the inorganic filler in the composition for protective layer formation is not limited in particular, it is preferably 20 mass % or more, more preferably 30 mass % or more, and still more preferably 40 mass % or more with respect to the total mass of the composition for protective layer formation. Within this range, the wear resistance of the protective layer is improved and the wear of the photoreceptor is further reduced. Further, as the content of the inorganic filler is increased, the effect due to the particles is improved, the cleaning property is improved, and the abrasion of the cleaning blade is further reduced. The content of the inorganic filler in the composition for protective layer formation is not limited in particular, it is preferably 90 mass % or less, more preferably 80 mass % or less, and still more preferably 70 mass % or more with respect to the total mass of the composition for protective layer formation. Within this range, the content of the polymerizable monomer in the composition for forming the protective layer is relatively increased, so that the crosslinking density of the protective layer is increased, the wear resistance is improved, and the wear of the photoreceptor is further reduced. Further, sufficient contact between the cleaning blade and the resin portion of the polymerized cured product constituting the protective layer is obtained, and the cleaning property is improved. Further, as a result of these, the wear of the cleaning blade is further reduced. The wear of the photoreceptor is further reduced.

The mass ratio of the polymerizable monomer in the protective layer forming composition to the inorganic filler (ratio of mass of polymerizable monomer/mass of inorganic filler in the protective layer forming composition) is not particularly limited, but it is preferably 0.1 or more, more preferably it is 0.2 or more, and still more preferably 0.4 or more. Within this range, the content of the polymerizable monomer in the composition for forming the protective layer is relatively increased, so that the crosslinking density of the protective layer is increased, the wear resistance is improved, and the wear of the photoreceptor is further reduced. Further, sufficient contact between the cleaning blade and the resin portion of the polymerized cured product constituting the protective layer is obtained, and the cleaning property is improved. Further, as a result of these, the wear of the cleaning blade is further reduced. The mass ratio of the polymerizable monomer in the protective layer-forming composition to the inorganic filler is not particularly limited, but it is preferably 10 or less, more preferably 2 or less, and still more preferably 1.5 or less. Within this range, the wear resistance of the protective layer is improved, and the wear of the photoreceptor is further reduced. Further, as the content of the inorganic filler is increased, the effect due to the particles is improved, the cleaning property is improved, and the abrasion of the cleaning blade is further reduced.

When the protective layer forming composition contains a polymerization initiator, the content thereof is not particularly limited, but it is preferably 0.1 mass parts or more, more preferably 1 mass part or more, still more preferably 5 mass part or more with respect to 100 mass parts of the polymerizable monomer.

In addition, the contents (in mass %) of the inorganic filler, the cured product of the polymerizable monomer, the optional polymerization initiator and other components (including the cured product if each is polymerizable) with respect to the total mass of the protective layer and the contents (in mass %) of the inorganic filler, the polymerizable monomer, and an optionally used polymerization initiator and other components with respect to the total mass of the protective layer forming composition are substantially the same.

The method for preparing the coating solution for forming the protective layer is not particularly limited, and a polymerizable monomer, an inorganic filler, an optional polymerization initiator and other components are added to a dispersion medium, and stirred and mixed until dissolved or dispersed.

The protective layer may be formed by applying a coating solution for forming a protective layer prepared by the above method on the photosensitive layer, followed by drying and curing.

In the process of coating, drying, and curing, the reaction between the polymerizable monomers, and further, when the inorganic filler has a polymerizable group, the reaction between the polymerizable monomer and the inorganic filler, and the reaction between the inorganic fillers are proceeded. A protective layer containing a cured product of the protective layer forming composition is formed.

The method of applying the protective layer forming coating solution is not particularly limited. Examples thereof are known method such as: a dip coating method, a spray coating method, a spinner coating method, a bead coating method, a blade coating method, a beam coating method, and a slide hopper method, and a circular slide hopper method.

After applying the coating solution, it is preferable to perform natural drying or heat drying to form a coating film, and then irradiate an active energy ray to cure the coating film. As the active energy ray, an ultraviolet ray or an electron beam is preferable, and an ultraviolet ray is more preferable.

As the ultraviolet light source, any light source that generates ultraviolet light can be used without limitation. For example, a low pressure mercury lamp, a medium pressure mercury lamp, a high pressure mercury lamp, an ultrahigh pressure mercury lamp, a carbon arc lamp, a metal halide lamp, a xenon lamp, or a flash (pulse) xenon lamp may be used. The irradiation conditions vary depending on each lamp, but the irradiation amount (integrated light amount) of ultraviolet rays is preferably 5 to 5000 mJ/cm², more preferably 10 to 2000 mJ/cm². Further, the illuminance of the ultraviolet rays is preferably 5 to 500 mW/cm², more preferably 10 to 100 mW/cm².

The irradiation time for obtaining the necessary irradiation amount (integrated light amount) of the active energy ray is preferably 0.1 second to 10 minutes, and more preferably 0.1 second to 5 minutes from the viewpoint of work efficiency.

In the process of forming the protective layer, drying can be performed before and after irradiation with active energy rays or during irradiation with active energy rays, and the timing of drying can be appropriately selected by combining these.

The drying conditions may be appropriately selected depending on the type of solvent and film thickness. The drying temperature is not particularly limited, but it is preferably 20 to 180° C., more preferably 80 to 140° C. The drying time is not particularly limited, but it is preferably 1 to 200 minutes, more preferably 5 to 100 minutes.

In the protective layer, the polymerizable monomer constitutes a polymer (polymerized cured product). Here, when the inorganic filler has a polymerizable group, in the protective layer, the polymerizable monomer and the inorganic filler having a polymerizable group constitute an integral polymer (polymerized cured product) that forms the protective layer. The fact that the polymerized cured product is a polymerized polymer of a polymerizable monomer (polymerized cured product) or a polymerized product of a polymerizable monomer and an inorganic filler having a polymerizable group (polymerized cured product) can be confirmed by analysis of the above polymerized product (polymerized cured product) by known instrumental analysis techniques such as pyrolysis GC-MS, nuclear magnetic resonance (NMR), Fourier transform infrared spectrophotometer (FT-IR), and elemental analysis.

### Toner

In the image forming method of the present invention, the toner includes toner mother particles and at least alumina particles as an external additive externally added to the toner mother particles. In this specification, “toner mother particles” constitutes a base of “toner particles.” The “toner mother particles” contain at least a binder resin, and may contain other components such as a colorant, a releasing agent (wax), and a charge controlling agent as necessary. The “toner mother particles” are referred to as “toner particles” by adding an external additive. The “toner” refers to an aggregate of “toner particles.”

### Toner Mother Particles

The composition and structure of the toner mother particles are not particularly limited, and known toner mother particles can be appropriately employed. Examples thereof include toner mother particles described in JP-A-2018-72694 and JP-A-2018-84645.

The binder resin is not particularly limited, and examples thereof include an amorphous resin or a crystalline resin. In this specification, an amorphous resin means a resin having a relatively high glass transition temperature (Tg) without having a melting point when differential scanning calorimetry (DSC) is performed. The amorphous resin is not particularly limited, and a known amorphous resin may be used. For example, a vinyl resin, an amorphous polyester resin, a urethane resin, and a urea resin may be cited. Among these, a vinyl resin is preferable from the viewpoint of easy control of thermoplasticity.

The vinyl resin is not particularly limited as long as a vinyl compound is polymerized, and examples thereof include a (meth)acrylate resin, a styrene-(meth)acrylate resin, and an ethylene-vinyl acetate resin. In this specification, a crystalline resin refers to a resin having a clear endothermic peak instead of a stepwise endothermic change in differential scanning calorimetry (DSC). The clear endothermic peak specifically means a peak whose half-value width of the endothermic peak is within 15° C. when measured at a rate of temperature increase of 10° C./min in differential scanning calorimetry (DSC).

The crystalline resin is not particularly limited, and a known crystalline resin can be used. Examples thereof include a crystalline polyester resin, a crystalline polyurethane resin, a crystalline polyurea resin, a crystalline polyamide resin, and a crystalline polyether resin. Among these, it is preferable to use a crystalline polyester resin. Here, the “crystalline polyester resin” is obtained by a polycondensation reaction of a divalent or higher carboxylic acid (polyvalent carboxylic acid) and a derivative thereof with a divalent or higher alcohol (polyhydric alcohol) and a derivative thereof. Among known polyester resins, the resin satisfying the endothermic characteristics as described above may be used. These resins may be used alone or in combination of two or more.

The colorant is not particularly limited, and a known colorant may be used. For example, carbon black, a magnetic substance, a dye, and a pigment may be mentioned.

The releasing agent is not particularly limited, and a known releasing agent may be used. For example, a polyolefin wax, a branched chain hydrocarbon wax, a long chain hydrocarbon wax, a dialkyl ketone wax, an ester wax, and an amide wax may be mentioned.

The charge controlling agent is not particularly limited, and a known charge controlling agent may be used. Examples thereof include nigrosine dyes, metal salts of naphthenic acid or higher fatty acids, alkoxylated amines, quaternary ammonium salt compounds, azo metal complexes, and salicylic acid metal salts or metal complexes.

The toner mother particles may be toner particles having a multilayer structure such as a core-shell structure including a core particle and a shell layer covering the surface of the core particle. The shell layer may not cover the entire surface of the core particle, and the core particle may be partially exposed. The cross section of the core-shell structure is confirmed by a known observation means such as a transmission electron microscope (TEM) or a scanning probe microscope (SPM).

The volume average particle diameter of the toner particles is preferably in the range of 3.0 to 6.5 μm. From the viewpoint of ease of production, the toner particles preferably have a volume average particle diameter of 3.0 μm or more. Further, from the viewpoint of preventing image defects due to low charge amount components without making the charge amount too low, the toner particles preferably have a volume average particle size of 6.5 μm or less. The average circularity of the toner particles is preferably 0.995 or less, more preferably 0.985 or less, and still more preferably in the range of 0.93 to 0.97. When the average circularity is in such a range, the toner particles are more easily charged.

### External Additive

The external additive includes metal oxide particles. The metal oxide particles as the external additive have a function of reducing electrostatic and physical adhesion between the transfer member and the toner and improving transferability. Further, it has a function of improving the removability of the residual toner to improve the cleaning property and reducing the wear of the photoreceptor and the cleaning blade.

### Alumina External Additive

The toner according to the present invention uses alumina particles as an external additive. Alumina refers to aluminum oxide represented by Al₂O₃, and forms such as α-type, γ-type, σ-type, and mixtures thereof are known. The alumina particles may be produced by a known method such as JP-A 2012-224542 and European Patent No. 0585544. As a method for producing alumina, the Bayer method is generally used, but in order to obtain high-purity and nano-sized alumina, hydrolysis method, gas phase synthesis method, flame hydrolysis method, and underwater spark discharge method may be mentioned.

The number average particle diameter of the alumina particles is preferably in the range of 10 to 60 nm. When the particle diameter is 60 nm or less, the fluidity of the toner is improved, and when the toner is supplied to the developing machine, the toner and the carrier are sufficiently mixed, and a more stable charge amount transition is obtained. By setting the particle diameter to 10 nm or more, the embedding of the alumina external additive in the toner base can be suppressed.

The number average particle diameter of the alumina particles can be measured as follows. Using a scanning electron microscope (SEM) “JSM-7401F” (manufactured by JEOL Ltd.), a SEM photograph magnified 50,000 times is taken with a scanner. With the image processing analyzer “LUZEX AP” (manufactured by Nireco), the alumina particles in the SEM photograph image are binarized, the ferret diameter in the horizontal direction is calculated, and the average value is defined as the number average particle diameter.

The surface of the alumina particles is preferably subjected to a hydrophobic treatment with a surface modifier (surface treatment agent), and the degree of hydrophobicity is preferably in the range of 40 to 70, for example. As a result, fluctuations in the charge amount due to environmental differences and fluctuations in the charge amount when shifting to the carrier may be more effectively suppressed. Moreover, it is preferable that the liberation rate of the surface modifier when subjected to the hydrophobization treatment is zero. When there is a liberated surface modifier, it moves to the carrier and the charge amount fluctuation increases. Examples of a method of hydrophobizing alumina particles with a surface modifier are as follows: a dry method such as a spray drying method of spraying a surface modifier or a solution containing the surface modifier on alumina particles suspended in a gas phase; a wet method in which alumina particles are immersed in a solution containing a surface modifier and drying; and a mixing method in which the surface modifier and alumina particles are mixed with a mixer.

The content of alumina particles is preferably in the range of 0.1 to 2 0 mass parts with respect to 100 mass parts of toner, for example. The effect of the present invention may be acquired more reliably when it is 0.1 mass part or more. When the amount is 2.0 mass parts or less, since the probability of the alumina particles receiving impact of the toner particles and carrier particles when the developer is stirred in the developing machine during low coverage printing may be suppressed, it is possible to make it difficult for the alumina particles to be embedded in the toner mother particles.

### Other External Additives

The external additive according to the present invention preferably contains other external additives in addition to the alumina particles from the viewpoint of controlling the fluidity and chargeability of the toner particles. Examples of such external additives include silica particles, titania particles, zirconia particles, zinc oxide particles, chromium oxide particles, cerium oxide particles, antimony oxide particles, tungsten oxide particles, tin oxide particles, tellurium oxide particles, manganese oxide, and boron oxide particles.

The number average particle diameter of the other external additives can be adjusted, for example, by classification or mixing of classified products. The number average particle size of other external additives may be measured by the same method as the method for measuring the number average particle size of alumina particles described above.

The surface of other external additives is preferably hydrophobized from the viewpoint of improving heat storage stability and environmental stability. A known surface modifier is used for the hydrophobic treatment. Examples of the surface modifier include silane coupling agents, titanate coupling agents, aluminate coupling agents, fatty acids, fatty acid metal salts, esterified products thereof, rosin acid, and silicone oil.

As other external additives, silica particles are preferably used from the viewpoint of imparting chargeability, and silica particles having a primary particle number average particle size in the range of 10 to 60 nm are more preferable. Thereby, the toner fluidity is improved, and when the toner is supplied to the developing machine, the toner particles and the carrier particles may be sufficiently mixed, so that a stable charge amount transition may be obtained. Further, it is preferable to use silica particles having a number average particle size of primary particles of 80 to 150 nm together silica particles having a number average particle size of primary particles of 10 to 60 nm. Thereby, the impact of the toner particles and the carrier particles when the developer is stirred in the developing machine at the time of low coverage printing may be reduced.

Organic particles may also be used as other external additives. As the organic particles, spherical organic particles having a number average particle diameter of about 10 to 2000 nm may be used. Specifically, homopolymers such as styrene and methyl methacrylate and organic particles of these copolymers may be used. A lubricant may also be used as another external additive. The lubricant is used for the purpose of further improving the cleaning property and transferability. Specific examples thereof include higher fatty acid metal salts such as: zinc, aluminum, copper, magnesium, or calcium stearate; zinc, manganese, iron, copper, or magnesium oleate; zinc, copper, magnesium, or calcium palmitate; zinc or calcium linolenate; and zinc or calcium ricinoleate.

### Production Method of Toner

The production method of the toner mother particles according to the present invention is not particularly limited. Examples of the method include known methods such as: a kneading pulverization method, a suspension polymerization, an emulsion aggregation method, a dissolution suspension method, a polyester extension method, and a dispersion polymerization method. Among these processes, preferred is an emulsion aggregation method in view of the uniformity of the particle size and control of the shape of the toner. In the emulsion aggregation method, a dispersion of binder resin particles dispersed with a surfactant or dispersion stabilizer is mixed with a dispersion of colorant particles as necessary to obtain a desired toner particle size. In this method, toner mother particles are manufactured by controlling the shape by agglomeration until the particles are further agglomerated to each other and further fusing the particles of the binder resin. Here, the binder resin particles may optionally contain a releasing agent and a charge controlling agent.

A mechanical mixing apparatus may be used as the external additive mixing treatment on the toner mother particles. The mechanical mixer used may be a HENSCHEL mixer, a NAUTA Mixer, or a TURBULAR mixer. Among these mixers, a HENSCHEL mixer, which is capable of imparting shear force to the particles, may be used to mix the materials for a longer time or with a stirring blade at a higher circumferential speed of rotation. When several kinds of external additives are used, all of the external additives may be mixed with the toner particles in one batch, or several aliquots of the external additives may be mixed with the toner particles.

### Developer

The toner may be used as a magnetic or non-magnetic one-component developer, and may be mixed with a carrier and used as a two-component developer. When the toner is used as a two-component developer, the magnetic particles made of known materials may be used as a carrier. Examples the carrier includes a ferromagnetic metal such as iron, an alloy of a ferromagnetic metal with aluminum and lead, a compound of a ferromagnetic metal such as ferrite and magnetite. Ferrite is particularly preferable.

### Electrophotographic Image Forming Apparatus

The electrophotographic image forming apparatus used in the electrophotographic image forming method of the present invention include: the above-described photoreceptor; a charging unit for charging the surface of the photoreceptor; an exposure unit for exposing a charged photoreceptor to form an electrostatic latent image; a developing unit for supplying toner to the photoreceptor on which the electrostatic latent image is formed to form a toner image; a transfer unit for transferring the toner image formed on the photoreceptor; and a cleaning unit for removing residual toner remaining on the surface of the photoreceptor. In addition to these devices, the image forming apparatus according to an aspect of the present invention preferably further includes a lubricant supply unit for supplying a lubricant to the surface of the photoreceptor.

Hereinafter, an image forming apparatus according to an embodiment of the present invention will be described with reference to the accompanying drawings. However, the present invention is not limited to only one form described below.

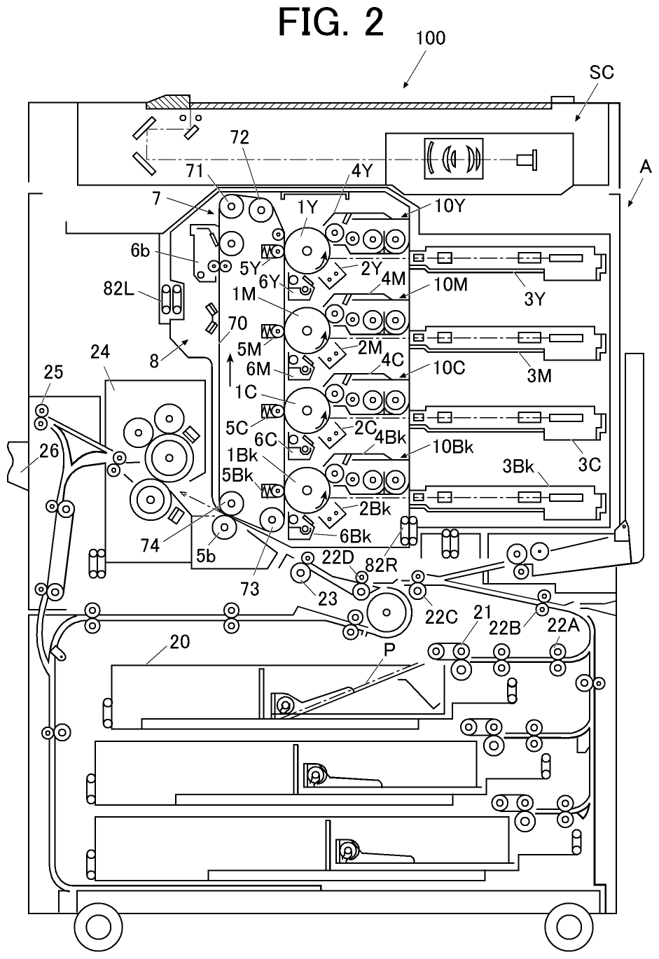

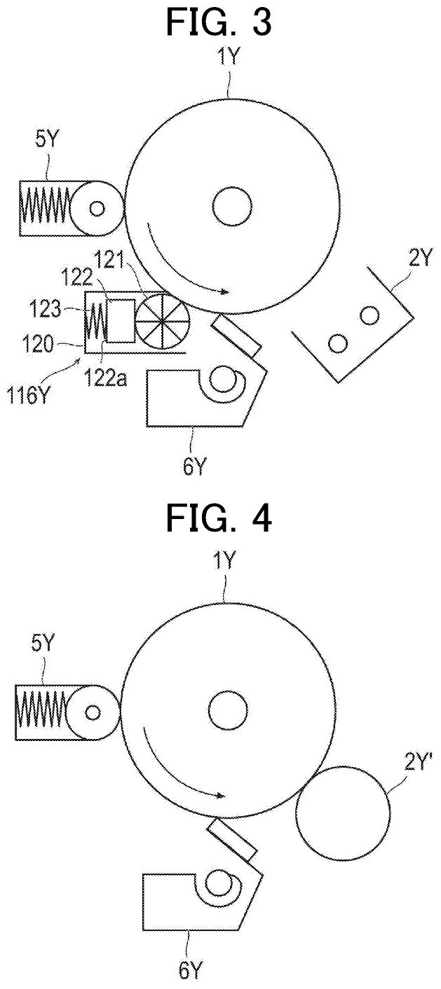

FIG. 2 is a schematic cross-sectional view showing an example of the configuration of an electrophotographic image forming apparatus according to an embodiment of the present invention. FIG. 3 is a schematic configuration diagram illustrating an example of a non-contact charging unit and a lubricant supply unit provided in the electrophotographic image forming apparatus according to an embodiment of the present invention. FIG. 4 is a schematic diagram illustrating an example of a proximity charging type charging unit provided in an image forming apparatus according to another embodiment of the present invention.

An image forming apparatus 100 illustrated in FIG. 2 is called a tandem color image forming apparatus, and it is provided with four sets of image forming units 10Y, 10M, 10C, and 10Bk, an endless belt-shaped intermediate transfer body unit 7, a paper feeding unit 21, and a fixing unit 24. A document image reading device SC is disposed on the upper part of the apparatus main body A of the image forming apparatus 100.

An image forming unit 10Y for forming a yellow image has a charging unit 2Y, an exposing unit 3Y, a developing unit 4Y, a primary transfer roller (primary transfer unit) 5Y and a cleaning unit 6Y, which are sequentially arranged around the drum-shaped photoreceptor 1Y along the rotation direction of the photoreceptor 1Y.

An image forming unit 10M for forming a magenta image has a charging unit 2M an exposing unit 3M, a developing unit 4M, a primary transfer roller (primary transfer unit) 5M and a cleaning unit 6M, which are sequentially arranged around the drum-shaped photoreceptor 1MY along the rotation direction of the photoreceptor 1M.

An image forming unit 10C for forming a cyan image has a charging unit 2C, an exposing unit 3C, a developing unit 4C, a primary transfer roller (primary transfer unit) 5C and a cleaning unit 6C, which are sequentially arranged around the drum-shaped photoreceptor 1C along the rotation direction of the photoreceptor 1C.

An image forming unit 10Bk for forming a black image has a charging unit 2Bk, an exposing unit 3Bk, a developing unit 4Bk, a primary transfer roller (primary transfer unit) 5Bk and a cleaning unit 6Bk, which are sequentially arranged around the drum-shaped photoreceptor 1Bk along the rotation direction of the photoreceptor 1Bk.

As the photoreceptors 1Y, 1M, 1C, and 1Bk, the photoreceptors according to the present invention described above are used.

The image forming units 10Y, 10M, 10C, and 10Bk have the same configuration except for the colors of toner images formed on the electrophotographic photoreceptors 1Y, 1M, 1C, and 1Bk. Thus, the following description focuses on the image forming unit 10Y as an example, and descriptions of the image forming units 10M, 10C, and 10Bk are omitted.

The image forming unit 10Y includes a charging unit 2Y, an exposure unit 3Y, a developing unit 4Y, a primary transfer roller (primary transfer unit) 5Y, and a cleaning unit 6Y around a photoreceptor 1Y that is an image forming body. A yellow (Y) toner image is formed on the photoreceptor 1Y. In the present embodiment, in the image forming unit 10Y, at least the photoreceptor 1Y, the charging unit 2Y, the developing unit 4Y, and the cleaning unit 6Y are integrated.

The charging unit 2Y is a unit that applies a uniform potential to the photoreceptor 1Y. For example, a non-contact type charging device such as a corona discharge type charger such as a scorotron as illustrated in FIGS. 2 and 3 may be used.

Further, as the charging unit 2Y, instead of a non-contact type charging unit, a charging unit 2Y′ that is a charging device of a proximity charging type that charges the charging roller in contact with or close to the photosensitive member as illustrated in FIG. 4 may also be used. The charging unit 2Y′ is a unit that charges the surface of the photoreceptor 1Y with a charging roller. The charging unit 2Y′ in this example includes a charging roller disposed in contact with the surface of the photoreceptor 1Y and a power source that applies a voltage to the charging roller. The charging roller includes, for example, a cored bar and an elastic layer that is laminated on the surface of the cored bar and reduces the charging noise and imparts elasticity to obtain uniform adhesion to the photoreceptor 1Y. On the surface of the elastic layer, a resistance control layer for obtaining a highly uniform electric resistance as a whole of the charging roller is laminated as necessary. A surface layer is laminated on the resistance control layer. The charging roller is urged in the direction of the photoreceptor 1Y by a pressing spring and is pressed against the surface of the photoreceptor 1Y with a predetermined pressing force to form a charging nip portion. The charging roller is rotated following the rotation of the photoreceptor 1Y.

In the case of using the charging unit 2Y′ as the charging unit 2Y, in the technique of the above-described Patent Document 1, the external additive is easily released from the toner at the time of cleaning. In some cases, contamination of the charging roller is caused by slipping of the agglomerates with the agent, and image defects may occur due to the contamination of the charging roller. However, in the electrophotographic image forming apparatus according to an aspect of the present invention, as described above, the release of the external additive due to the rushing of the residual toner and the convection of the residual toner when the residual toner enters the cleaning blade is suppressed. The slippage of the free external additive and its aggregate, and the aggregate of the toner and the free external additive are reduced. Thereby, charging roller contamination by the free external additive is suppressed, and the occurrence of image defects is reduced.

The exposure unit 3Y is a unit that performs exposure based on an image signal (yellow) on the photoreceptor 1Y to which a uniform potential is applied by the charging unit 2Y, and forms an electrostatic latent image corresponding to a yellow image. As the exposure unit 3Y, for example, a device composed of an LED having light emitting elements arranged in an array in the axial direction of the photoreceptor 1Y and an imaging element, or a laser optical system is used.

The developing unit 4Y includes, for example, a developing sleeve that contains a magnet and rotates while holding the developer, and a voltage applying device that applies a DC and/or AC bias voltage between the photoreceptor 1Y and the developing sleeve.

The primary transfer roller 5Y is a device (primary transfer unit) for transferring the toner image formed on the photoreceptor 1Y to the endless belt-like intermediate transfer body 70. The primary transfer roller 5Y is disposed in contact with the intermediate transfer body 70.

For example, as illustrated in FIG. 3, the lubricant supply unit 116Y for supplying (applying) the lubricant to the surface of the photoreceptor 1Y is provided on the downstream side of the primary transfer roller (primary transfer unit) 5Y and on the upstream side of the cleaning unit 6Y. However, it may be located in the downstream of the cleaning unit 6Y.

As the brush roller 121 constituting the lubricant supply unit 116Y, for example, the following device may be cited. A pile woven fabric in which a bundle of fibers is woven into a base fabric as a pile yarn and made into a ribbon-like fabric, the brushed surface is spiraled around the metal shaft, and wrapped around and adhered. In this example, the brush roller 121 is formed by forming a long woven fabric formed of resin brush fibers such as polypropylene at a high density on the peripheral surface of a roller base.

The brush hair is preferably a straight hair type that is raised in a direction perpendicular to the metal shaft from the viewpoint of the ability to apply the lubricant. The yarn used for the brush hair is preferably a filament yarn, and examples of the material include polyamides such as 6-nylon and 12-nylon, and synthetic resins such as polyester, acrylic resin, and vinylon. A material in which a metal such as carbon or nickel is kneaded for the purpose of enhancing conductivity may be used. It is preferable that the thickness of the brush fiber is, for example, 3 to 7 denier, the bristle length of the brush fiber is, for example, 2 to 5 mm, the electrical resistivity of the brush fiber is, for example, 1×10¹⁰ Ω or less, and the Young's modulus of the brush fiber is 4900 to 9800 N/mm², the planting density of brush fibers (number of brush fibers per unit area) is preferably, for example, 50,000 to 200,000 fibers/square inch (50 to 200 k fibers/inch²). The biting amount of the brush roller 121 with respect to the photoreceptor is preferably 0.5 to 1.5 mm. The rotation speed of the brush roller is, for example, 0.3 to 1.5 in terms of the peripheral speed ratio of the photoreceptor, and the rotation may be in the same direction as the rotation direction of the photoreceptor or in the opposite direction.

The pressure spring 123 is used to press the lubricant 122 in the direction close to the photoreceptor 1Y so that the pressing force of the brush roller 121 against the photoreceptor 1Y is, for example, 0.5 to 1.0 N.

In the lubricant supply unit 116Y, the amount of lubricant consumed per cumulative length of 1 km on the surface of the rotating photoreceptor is preferably 0.05 to 0.27 g/km, more preferably 0.05 to 0.15 g/km. For example, the pressing force of the lubricant 122 against the brush roller 121 and the rotation speed of the brush roller 121 are adjusted so as to achieve the above-described amount.

The type of the lubricant 122 is not particularly limited and can be appropriately selected from known ones, but preferably contains a fatty acid metal salt.

As the fatty acid metal salt, a metal salt of a saturated or unsaturated fatty acid having 10 or more carbon atoms is preferable. Examples thereof include zinc laurate, barium stearate, lead stearate, iron stearate, nickel stearate, cobalt stearate, copper stearate, strontium stearate, calcium stearate, cadmium stearate, magnesium stearate, zinc stearate, aluminum stearate, indium stearate, potassium stearate, lithium stearate, sodium stearate, zinc oleate, magnesium oleate, iron oleate, olein Cobalt acid, copper oleate, lead oleate, manganese oleate, aluminum oleate, zinc palmitate, cobalt palmitate, lead palmitate, magnesium palmitate, aluminum palmitate, calcium palmitate, lead caprate, zinc linoleate, cobalt linoleate, calcium linoleate, zinc ricinoleate, cadmium ricinoleate. Among these, zinc stearate is particularly preferable from the viewpoint of the effect as a lubricant, availability, and cost.

As the lubricant supply unit, instead of the unit for applying the solid lubricant 122 by the brush roller 116Y as described above, the following unit may be used. By externally adding a fine powder lubricant to the toner mother particles in the preparation of the toner, a unit for supplying a lubricant to the surface of the electrophotographic photoreceptor by the action of a developing electric field formed in the developing unit may also be used.

The cleaning unit 6Y includes a cleaning blade and a brush roller provided on the upstream side of the cleaning blade.

The endless belt-shaped intermediate transfer body unit 7 has an endless belt-shaped intermediate transfer body 70 that is wound around a plurality of rollers 71 to 74 and is rotatably supported. In the endless belt-shaped intermediate transfer body unit 7, a cleaning unit 6b for removing toner is disposed on the intermediate transfer body 70.

Further, the image forming units 10Y, 10M, 10C, and 10Bk and the endless belt-shaped intermediate transfer body unit 7 constitute a housing 8. The housing 8 is configured to be drawable from the apparatus main body A through support rails 82L and 82R.

As the fixing unit 24, for example, a heating roller fixing method is mentioned. This fixing method uses a composition of a heating roller including a heating roller provided with a heating source therein and a pressure roller provided in pressure contact with the heating roller so as to form a fixing nip portion.

In the above-described embodiment, the image forming apparatus 100 is a color laser printer, but it may be a monochrome laser printer, a copier, or a multifunction machine. The exposure light source may be a light source other than a laser, such as an LED light source.

The electrophotographic image forming apparatus according to an aspect of the present invention may further include a lubricant removing unit that removes the lubricant from the surface of the photoreceptor, when needed. Specifically, for example, in the image forming apparatus 100, a lubricant supply unit 116Y is provided on the downstream side of the cleaning unit 6Y and the upstream side of the charging unit 2Y in the rotation direction of the photoreceptor 1Y. Further, a lubricant removing unit is arranged on the downstream side of the lubricant supply unit 116Y and on the upstream side of the charging unit 2Y to constitute an image forming apparatus.

The lubricant removing unit is preferably a device for removing the lubricant by a mechanical action when the removing member contacts the surface of the photoreceptor 1Y, and a removing member such as a brush roller or a foaming roller may be used.

The present invention has a higher effect when the printing speed is increased. Thus, it is preferable that the electrophotographic image forming apparatus can realize a printing speed of 70 sheets/minute (A4 horizontal) or more. As mentioned above, although embodiment of the present invention was described, the present invention is not limited to the described embodiment, and a various change me be added.

### EXAMPLES

Hereinafter, the present invention will be specifically described with reference to examples, but the present invention is not limited thereto. In the following examples, the operation was performed at room temperature (25° C.) unless otherwise specified. Unless otherwise specified, “%” and “part” mean “mass %” and “mass part,” respectively.

### Preparation of Composite Particles (Core-Shell Particles)

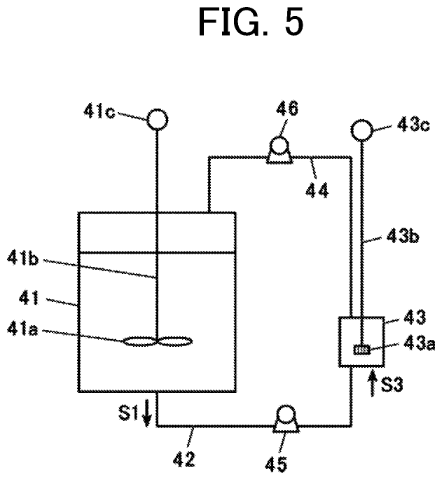

Using the production apparatus illustrated in FIG. 5, composite particles in which a coating layer (shell) of tin oxide (SnO₂) was formed on the surface of a barium sulfate (BaSO₄) core material (core) were produced. In Table I below, the composite particle was expressed as “SnO₂/BaSO₄.”

Specifically, 3500 cm³ of pure water was introduced into the mother liquor tank 41, and then 900 g of a spherical barium sulfate core material having a number average primary particle size of 95 nm was introduced and circulated for 5 passes. The flow rate of the slurry flowing out from the mother liquor tank 41 was 2280 cm³/min. Further, the stirring speed of the strong dispersion device 43 was set to 16000 rpm. After completion of the circulation, the slurry was made up to a total volume of 9000 cm³ with pure water, and 1600 g of sodium stannate and 2.3 cm³ of an aqueous sodium hydroxide solution (concentration 25 N) were added thereto and circulated for 5 passes. A mother liquor was thus obtained.

While circulating this mother liquor so that the flow rate S1 flowing out of the mother liquor tank 41 is 200 cm³, 20% sulfuric acid was supplied to a homogenizer (“magic LAB (registered trademark)” manufactured by IKA Japan Co., Ltd.) as a strong dispersion device 43. The supply speed S3 was set to 9.2 cm³/min. The volume of the homogenizer was 20 cm³, and the stirring speed was 16000 rpm. Circulation was performed for 15 minutes, during which time sulfuric acid was continuously supplied to the homogenizer to obtain a slurry containing particles.

The obtained slurry was subjected to repulp washing until the electrical conductivity became 600 μS/cm or less, and then subjected to Nutsche filtration to obtain a cake. This cake was dried in air at 150° C. for 10 hours. Next, the dried cake was pulverized, and the pulverized powder was reduced and fired at 450° C. for 45 minutes in an atmosphere of 1 volume % H₂/N₂. Thus, composite particles having a number average primary particle size of 100 nm, in which a tin oxide shell was formed on the surface of the barium sulfate core material (core), were prepared.

Here, in the production apparatus illustrated in FIG. 5, reference numerals 42 and 44 denote circulation pipes that form a circulation path between the mother liquor tank 41 and the strong dispersion apparatus 43, and reference numerals 45 and 46 denote pumps provided with circulation pipes 42 and 44. Reference numeral 41a indicates a stirring blade, reference numeral 43a indicates a stirring portion, reference numerals 41b and 43b indicate shafts, and reference numerals 41c and 43c indicate motors.

### Preparation of Surface-Modified Metal Oxide Particles (Surface-Modified Inorganic Filler) [P-1]

10 g of tin oxide (number average primary particle size=20 nm) was added to 100 mL of ethanol, and dispersed for 60 minutes using a US homogenizer. Next, 0.3 g of 3-methacryloxypropyltrimethoxysilane (a silane coupling agent having a radical polymerizable functional group (S-16)) and 10 mL of ethanol were added and dispersed for 30 minutes using a US homogenizer. After removing the solvent with an evaporator, the filler particles [a] subjected to reactive surface modification were obtained by heating at 120° C. for 1 hour. 10 g of the obtained filler particles [a] were added to 40 g of 2-butanol and dispersed for 60 minutes using a US homogenizer. Next, 0.5 g of “KF-9908” (a surface modifying agent having a silicone chain in the side chain of the silicone main chain (hydrophobic surface modifying agent)) (manufactured by Shin-Etsu Chemical Co., Ltd.) and 10 mL of 2-butanol were added for another 30 minutes. Dispersion was performed using a US homogenizer. After the dispersion, the solvent was removed by an evaporator and dried at 120° C. for 1 hour to prepare surface-modified metal oxide particles [P-1].

### Preparation of Surface-Modified Metal Oxide Particles [P-2] to [P-11]

Surface-modified metal oxide particles [P-2] to [P-11] were prepared in the same manner as preparation of the surface-modified metal oxide particles [P-1] except that the types and amounts of unmodified metal oxide particles, reactive surface modifiers, and hydrophobic surface modifiers used were changed as indicated in the following Table I. The unmodified metal oxide particles used in the preparation of the surface-modified metal oxide particles [P-4] to [P-9] and [P-11] were composite particles having a number average primary particle size of 100 nm prepared as described above. The unmodified metal oxide particles used in the preparation of the surface-modified metal oxide particles [P-10] were composite particles having a number average primary particle size of 200 mm Further, in the preparation of the surface-modified metal oxide particles [P-9], only the surface modification with KF9908 was performed without performing the surface modification with the silane coupling agent having a radical polymerizable functional group. Further, in the preparation of the surface-modified metal oxide particles [P-11], only the surface modification with the silane coupling agent having a radical polymerizable functional group was performed without performing the surface modification with the silicone surface modifier.

TABLE I

| | Unmodified metal oxide particles | | | | | |
|---|---|---|---|---|---|---|
| Surface-modified | | Number average | Hydrophobic surface modifier | | Reactive surface modifier | |
| metal oxide | | primary particle size | | Amount of surface | Type of surface | Amount of surface |
| particles No. | Type of particle | (nm) | Type of surface modifier | modifier (g) | modifier | modifier (g) |
| P- 1 | SnO₂ | 20 | KF-9908(side chain) | 0.5 | S-16 | 0.3 |
| P- 2 | SnO₂ | 50 | KF-9908(side chain) | 0.3 | S-16 | 0.2 |
| P- 3 | SnO₂ | 250 | KF-9908(side chain) | 0.2 | S-16 | 0.1 |
| P- 4 | BaSO₄/SnO₂ | 100 | n-Octyltrimethoxysilane | 0.3 | S-16 | 0.3 |
| | Composite particles | | | | | |
| P- 5 | BaSO₄/SnO₂ | 100 | KF-99(straight chain) | 0.3 | S-16 | 0.3 |
| | Composite particles | | | | | |
| P- 6 | BaSO₄/SnO₂ | 100 | KP-574(side chain) | 0.3 | S-16 | 0.3 |
| | Composite particles | | | | | |
| P- 7 | BaSO₄/SnO₂ | 100 | KF-9908(side chain) | 0.3 | S-16 | 0.3 |
| | Composite particles | | | | | |
| P- 8 | BaSO₄/SnO₂ | 100 | KF-9909(side chain) | 0.3 | S-16 | 0.3 |
| | Composite particles | | | | | |
| P- 9 | BaSO₄/SnO₂ | 100 | KF-9908(side chain) | 0.6 | No surface modification | |
| | Composite particles | | | | | |
| P-10 | BaSO₄/SnO₂ | 200 | KF-9908(side chain) | 0.2 | S-16 | 0.2 |
| | Composite particles | | | | | |

| | | | | | |
|---|---|---|---|---|---|
| P-11 | BaSO₄/SnO₂ | 100 | No surface modification | S-16 | 0.3 |
| | Composite particles | | | | |

Details of the surface modifier described in Table I are indicated below.

“KF-9908”: Branched silicone surface modifier having a silicone chain in the side chain of the silicone main chain (manufactured by Shin-Etsu Chemical Co., Ltd.)

“KF-9909”: Branched silicone surface modifier having a silicone chain in the side chain of the silicone main chain (manufactured by Shin-Etsu Chemical Co., Ltd.)

“KF-574”: Branched silicone surface modifier having a silicone chain in the side chain of the acrylic main chain (manufactured by Shin-Etsu Chemical Co., Ltd.)

“KF-99”: Linear silicone surface modifier (methyl hydrogen silicone oil) (manufactured by Shin-Etsu Chemical)

### Preparation of Photoreceptor

### Preparation of Photoreceptor [1]

### (1) Preparation of Conductive Support

A conductive support was prepared through milling the surface of a cylindrical aluminum support.

### (2) Formation of Intermediate Layer

The intermediate layer composition having the following component was mixed, and dispersed for 10 hours in a batch mode using a sand mill as a disperser.

| | |
|---|---|
| Polyamide resin “X 1010” | 10 mass parts |
| (made by Daicel-Degussa Ltd.): | |
| Titanium oxide “SMT500SAS” | 11 mass parts |
| (mad by TEIKA Co. Ltd.): | |
| Ethanol | 200 mass parts |

The coating liquid for forming an intermediate layer was applied to a surface of the conductive support through dip coating. Subsequently, the coated layer was dried at 110° C. for 20 minutes to obtain an intermediate layer having a dry film thickness of 2 μm.

### (3) Formation of Charge Generation Layer

A coating liquid for forming a charge generation layer was prepared through mixing of the following materials with a circulating ultrasonic homogenizer “RUS-600 TCVP” (made by Nissei Corporation). The dispersion was done under the conditions of 19.5 kHz, 600 W, circulating flow amount of 40 L/h for 0.5 hours. The above-described liquid for forming a charge generation layer was applied onto the intermediate layer through dip coating, and the resultant film was dried to form a charge generation layer having a thickness of 0.3 μm.

Charge generation material (Titanylphthalocyanine (having at least a maximum diffraction peak at 8.3°, 24.7°, 25.1°, and 26.5° as measured by Cu-Kα X-ray diffractometry) with (2R,3R)-2,3-butandiol (1:1 aduct) and

| | |
|---|---|
| non-adduct of titanylphthalocyanine mixed crystal): | 24 mass parts |
| Poly(vinyl butyral)resin “S-LEC BL-1” | 12 mass parts |
| (made by Sekisui Chemical Co. Ltd.): | |
| 3-Methyl-2-butanone/cyclohexanone (4/1, volume | 400 mass parts |
| ratio): | |

### (4) Formation of Charge Transport Layer

A coating liquid for forming a charge transport layer was prepared through mixing and dissolution of the following materials.

| | | |
|---|---|---|
| Charge transport material (2): | 60 | mass parts |
| Polycarbonate resin “Z300” (made by | 100 | mass parts |
| Mitsubishi Gas Chemical Co. Inc.): | | |
| Antioxidant Irganox 1010 (made by Ciba | 4 | mass parts |
| Specialty Chemicals Inc.): | | |

Charge transport material (2)

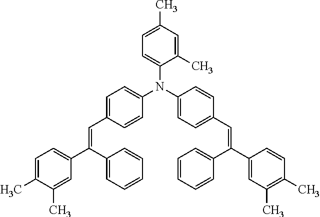

This charge transport layer coating solution was applied onto the charge generation layer by a dip coating method and dried at 120° C. for 70 minutes to form a charge transport layer having a dry film thickness of 24 μm.

### (5) Formation of Protective Layer

A coating liquid for forming a protective layer was prepared by dissolving and dispersing the following materials.

| | | |
|---|---|---|
| Polymerizable monomer M2: | 60 | mass parts |
| Charge transport material (3): | 20 | mass parts |
| Surface-modified tin oxide particles (surface- | 100 | mass parts |
| modified metal oxide particles [P-1]): | | |
| Polymerization initiator (“Irgacure 819” | 5 | mass parts |
| made by BASF Japan Co. Ltd.): | | |
| 2-Butanol: | 300 | mass parts |
| Tetrahydrofuran: | 30 | mass parts |

Charge transport material (3)

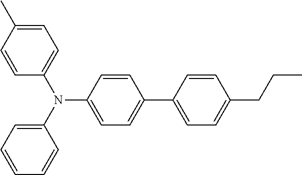 [SMILES: CCCc1ccc(-c2ccc(N(c3ccccc3)c3ccc(C)cc3)cc2)cc1]

The obtained coating liquid for forming a protective layer was applied on the charge transport layer with a circular slide hopper coating apparatus to form a coated layer. The coated layer was irradiated with UV rays with a metal halide lamp for 1 minute. Then the coated layer was dried to obtain a protective layer having a dry film thickness of 3.0 μm. An electrophotographic photoreceptor [1] was thus produced.

### Preparation of Photoreceptors [2] to [11]

Photoreceptors [2] to [11] were prepared in the same manner as preparation of the photoreceptor [1] except that the surface-modified metal oxide particles [P-1] used in the production of the protective layer of the photoreceptor [1] were changed as indicated in Table III.

### Preparation of Photoreceptor [12]

Photoreceptor [12] was prepared in the same manner as preparation of the photoreceptor [1] except that the radical polymerizable monomer M2 used in the preparation of the protective layer of the photoreceptor [1] was changed to 100 mass parts and the surface-modified metal oxide particles [P-1] were changed to 60 mass parts of [P-7].

### Preparation of Photoreceptor [13]

Photoreceptor [13] was prepared in the same manner as preparation of the photoreceptor [1] except that the radical polymerizable monomer M2 used in the preparation of the protective layer of the photoreceptor [1] was changed to 40 mass parts and the surface-modified metal oxide particles [P-1] were changed to 120 mass part.

### Measurement of the Average Height R of the Protrusions in the Protective Layer of the Photoreceptor

The obtained photoreceptor was photographed (magnification: 10,000 times, acceleration voltage: 2 kV) using a scanning electron microscope (SEM) (“JSM-7401F,” manufactured by JEOL Ltd.). By visually observing, it was confirmed that the convex structure of the protective layer was composed of raised metal oxide particles. Further, after the photographic image was captured by a scanner into an image processing analysis apparatus (“LUZEX AP,” manufactured by Nireco Co., Ltd.), the photographic image was binarized with the maximum value +30 level of the monochrome histogram as a threshold value. The distance between adjacent centroids was calculated, and this was set as the average distance R between the convex portions of the convex structure formed by the protrusion of the inorganic filler in the protective layer, and it is indicated in Table III below.

### Preparation of Toner

### Preparation of External Additive Alumina Particles

### Production of Alumina Particles [1]

320 kg/h of aluminum trichloride (AlCl₃) was evaporated in an evaporator at about 200° C., and chloride vapor was passed through the mixing chamber of the burner with nitrogen. Here, the gas stream was mixed with 100 Nm³/h of hydrogen and 40 Nm³/h of air and fed to the flame via a central tube (diameter 7 mm). As a result, the burner temperature was 230° C., and the discharge speed of the tube was about 35.8 m/s. 0.05 Nm³/h of hydrogen was supplied as a jacket type gas through the outer tube.

The gas was combusted in the reaction chamber and was cooled to about 110° C. in the downstream agglomeration zone. There, agglomeration of primary particles of alumina was performed. The resulting aluminum oxide particles were separated from the hydrochloric acid-containing gas produced in a filter or cyclone, and the adhesive chloride was removed by treating the powder with wet air at about 500 to 700° C. Thus, alumina particles 1a were obtained. The alumina particles obtained above were put in a reaction vessel. While stirring the powder with a rotating blade in a nitrogen atmosphere, 20 g of the hydrophobizing agent isobutyltrimethoxysilane diluted with 60 g of hexane with respect to 100 g of the alumina powder was added. The mixture was heated and stirred at 200° C. for 120 minutes and then cooled with cooling water to obtain alumina particles [1].

### Preparation of Alumina Particles [2] to [5]

Alumina particles [2] to [5] described in Table II were prepared in the same mariner as preparation of the alumina particles [1] by adjusting various conditions such as the reaction conditions described above, the residence time in the flame or the length of the agglomeration zone.

TABLE II

| Alumina particles | Number average primary |
|---|---|
| No. | particle size (nm) |
| 1 | 20 |
| 2 | 5 |
| 3 | 10 |
| 4 | 60 |
| 5 | 80 |

### Production of Toner

### Production of Toner [1]

### (1) Preparation of Toner Mother Particles 1

### (1.1) Preparation of Resin Particle A Dispersion for Core

### (1.1.1) First Stage Polymerization

In a reaction vessel equipped with a stirrer, a temperature sensor, a temperature control device, a cooling tube and a nitrogen introducing device, an anionic surfactant solution prepared by dissolving 2.0 mass parts of sodium lauryl sulfate in 2900 mass parts was charged. While stirring at a stirring speed of 230 rpm in a nitrogen flow, the inner temperature was raised to 80° C.

To the anionic surfactant solution, 9.0 mass parts of potassium persulfate (KPS) were added as a polymerization initiator, and the inner temperature was set to 78° C. To the anionic surfactant solution to which the polymerization initiator was added, the monomer solution 1 in which the following components were mixed in the following amounts was added dropwise over 3 hours. After completion of the dropping, polymerization (first stage polymerization) was carried out by heating and stirring at 78° C. for 1 hour to prepare a dispersion of resin particles a1.

(Monomer solution 1)

| | |
|---|---|
| Styrene: | 540 mass parts |
| n-Butyl acrylate: | 154 mass parts |
| Methacrylic acid: | 77 mass parts |
| n-Octylmercaptan: | 17 mass parts |

### (1.1.2) Second Stage Polymerization: Formation of Intermediate Layer

The following components were mixed in the following amounts, and 51 mass parts of paraffin wax (melting point: 73° C.) was added as an anti-offset agent, heated to 85° C. and dissolved to prepare a monomer solution 2.

(Monomer solution 2)

| | |
|---|---|
| Styrene: | 94 mass parts |
| n-Butyl acrylate: | 27 mass parts |
| Methacrylic acid: | 6 mass parts |
| n-Octylmercaptan: | 1.7 mass parts |

A surfactant solution prepared by dissolving 2 mass parts of sodium lauryl sulfate as an anionic surfactant in 1100 mass parts of ion-exchanged water was heated to 90° C., and a dispersion of resin fine particles a1 was added to the surfactant solution. After adding 28 mass parts in terms of solid content of the particles a1, the monomer solution 2 was mixed for 4 hours with a mechanical disperser having a circulation path (“CLEAMIX (registered trademark),” manufactured by M Technique Co., Ltd.). The mixture was dispersed to prepare a dispersion containing emulsified particles having a dispersed particle diameter of 350 nm. An initiator aqueous solution in which 2.5 mass parts of KPS were dissolved in 110 mass parts of ion-exchanged water as a polymerization initiator was added to the dispersion, and this system was polymerized by heating and stirring at 90° C. for 2 hours (second stage polymerization) to prepare a dispersion of resin particles a11.

### (1.1.3) Third-Stage Polymerization: Formation of Outer Layer (Preparation of Core Part Resin Particles A)

An initiator aqueous solution in which 2.5 mass parts of KPS was dissolved in 110 mass parts of ion-exchanged water as a polymerization initiator was added to the dispersion of resin particles a11, and the following components were blended in the following amounts under a temperature condition of 80° C. The monomer solution 3 was added dropwise over 1 hour. After completion of the dropwise addition, polymerization (third stage polymerization) was carried out by heating and stirring for 3 hours. Then, the system was cooled to 28° C. and prepared the dispersion liquid of the resin particle A for core parts in which the resin particle A for core parts was disperse in the anionic surfactant solution. The glass transition temperature of the resin particle A for core part was 45° C., and the softening point was 100° C.

(Monomer solution 3)

| | |
|---|---|
| Styrene: | 230 mass parts |
| n-Butyl acrylate: | 78 mass parts |
| Methacrylic acid: | 16 mass parts |
| n-Octylmercaptan: | 4.2 mass parts |

### (1.2) Preparation of Resin Particle B Dispersion for Shell Layer

### (1.2.1) Synthesis of Resin for Shell Layer (Styrene-Acryl Modified Polyester Resin B)

In a 10 L four-necked flask equipped with a nitrogen introduction tube, a dehydration tube, a stirrer, and a thermocouple, the following component 1 was added in the following amount and the mixture was subjected to a condensation polymerization reaction at 230° C. for 8 hours, and further at 8 kPa for 1 hour. The reaction mixture was allowed to cool to 160° C.

(Component 1)

| | |
|---|---|
| Bisphenol A propylene oxide 2-mole adduct: | 500 mass parts |
| Terephthalic acid: | 117 mass parts |
| Fumaric acid: | 82 mass parts |
| Esterification catalyst (tin octylate): | 2 mass parts |

Subsequently, the mixture containing the following component 2 with the following amount was dropped to the cooled solution obtained above over 1 hour through the dropping funnel. After completion of the dropping, the addition polymerization reaction was continued for 1 hour while maintaining the temperature at 160° C. Thereafter, the temperature was raised to 200° C. and the system was held at 10 kPa for 1 hour. Then unreacted acrylic acid, styrene, and butyl acrylate were removed to obtain a styrene-acryl modified polyester resin B. The resulting styrene-acryl modified polyester resin B had a glass transition temperature of 60° C. and a softening point of 105° C.

(Component 2)

| | |
|---|---|
| Acrylic acid: | 10 mass parts |
| Styrene: | 30 mass parts |
| Butyl acrylate: | 7 mass parts |
| Polymerization initiator (di-t-butyl peroxide): | 10 mass parts |

### (1.2.2) Preparation of Resin Particle B Dispersion for Shell Layer

100 mass parts of the obtained styrene-acryl modified polyester resin B was pulverized with a pulverizer (Landel mill, RM type; Tokuju Co., Ltd.). The system was mixed with 638 mass parts of a sodium lauryl sulfate solution having a concentration of 0.26 mass % prepared in advance. While stirring, an ultrasonic homogenizer (“US-150T” manufactured by Nippon Seiki Seisakusho Co., Ltd.) was used for ultrasonic dispersion for 30 minutes at V-LEVEL, 300 μA. A dispersion liquid of the shell layer resin particles B in which the shell layer resin particles B having a number-based median diameter (D50) of 250 nm were dispersed was prepared.

### (1.3) Preparation of Colorant Particle Dispersion 1

90 mass parts of sodium dodecyl sulfate was dissolved in 1600 mass parts of ion-exchanged water with stirring, and 420 mass parts of carbon black (“Mogul L,” manufactured by Cabot) was gradually added while stirring this solution. Subsequently, the colorant particle dispersion liquid 1 in which the colorant particles were dispersed was prepared by performing a dispersion treatment using a stirrer (“CLEARMIX (registered trademark),” manufactured by M Technique Co., Ltd.). The particle diameter of the colorant particles in this dispersion was measured using a Microtrac particle size distribution measuring apparatus (“UPA-150,” manufactured by Microtrac Bell Co., Ltd.) and it was found to be 117 nm.

### (1.4) Preparation of Toner Particles 1 (Agglomeration, Fusion-Washing-Drying)

In a reaction vessel equipped with a stirrer, a temperature sensor, and a cooling tube, 288 mass parts (in terms of solid content) of the dispersion of core part resin particles A, and 400 mass parts of ion-exchanged water were charged. Then, 5 mol/L sodium hydroxide aqueous solution was added, and pH (25° C.) was adjusted to 10.

Thereafter, 40 mass parts (in terms of solid content) of the colorant particle dispersion 1 was added. Next, an aqueous solution in which 60 mass parts of magnesium chloride was dissolved in 60 mass parts of ion-exchanged water was added over 10 minutes at 30° C. with stirring. Thereafter, the temperature was raised after being allowed to stand for 3 minutes, and the temperature of the system was raised to 80° C. over 60 minutes, and the particle growth reaction was continued while maintaining 80° C. In this state, the particle size of the core particle was measured with a precision particle size distribution measuring device (“MULTISIZER 3,” manufactured by Coulter Beckman). When the number-based median diameter (D₅₀) reaches 5.8 μm, 72 mass parts (in terms of solid content) of the dispersion of resin particles B for shell layer was added over 30 minutes. At the point that the supernatant of the reaction solution became transparent, an aqueous solution in which 190 mass parts of sodium chloride was dissolved in 760 mass parts of ion-exchanged water was added to stop particle growth. Further, the temperature was raised and the mixture was heated and stirred at 90° C. to advance the fusion of the particles. Using an apparatus for measuring the average circularity of toner (“FPIA-2100,” manufactured by Sysmex) (4000 HPF detected), when the average circularity reached 0.945, the toner was cooled to 30° C. A dispersion of toner mother particles 1 was obtained.

The dispersion of toner mother particles 1 was solid-liquid separated with a centrifuge to form a wet cake of toner mother particles 1. This wet cake was washed with ion exchange water at 35° C. until the electric conductivity of the filtrate reached 5 μS/cm, and then transferred to an airflow dryer (“Flash Jet Dryer,” manufactured by Seishin Enterprise Co., Ltd.). It was dried to 0 5 mass % to obtain toner mother particles 1.

When the particle size of the toner base particles 1 was measured with a precision particle size distribution analyzer (“MULTISIZER 3,” manufactured by Coulter Beckman), the number-based median diameter (D₅₀) was 6.0 μm.

### (2) Preparation of Toner [1]

To 100 mass parts of the prepared toner mother particles 1, 0.3 mass parts of silica particles 1 (HMDS treatment, hydrophobicity 72, number average particle size=110 nm), 0.8 mass parts of silica particles 2 (HMDS treatment, hydrophobicity 67, number average particle size=12 nm), and 0.5 mass parts of the prepared alumina particles [1] were added as external additives. This mixture was added to a Henschel mixer type “FM20C/I” (manufactured by Nippon Coke Industries Co., Ltd.), the rotation speed was set so that the blade tip peripheral speed was 40 m/s, and stirring was performed for 20 minutes. Thereby toner [1] was prepared.

### Preparation of Toners [2] to [5]

Toners [2] to [5] were prepared in the same manner as preparation of the toner [1] except that alumina particles [1] were changed to alumina particles [2] to [5].

### Preparation of Toner [6]

Toner [6] was prepared in the same manner as preparation of the toner [1] except that alumina particles [1] were changed to titania particles (octyltrimethoxysilane treatment, hydrophobization degree 75, number average particle size=25 nm).

### Preparation of Developer

100 mass parts of Mn—Mg based “ferrite particles 1” having a volume average particle size of 40 μm and a saturation magnetization of 63 A·m²/kg and 2.0 mass parts of a copolymer of cyclohexyl methacrylate-methyl methacrylate (mass ratio of monomer: 50:50) (weight average molecular weight: 500,000) as a coating resin were charged into a high-speed stirring mixer equipped with a horizontal stirring blade. After mixing and stirring at 22° C. for 15 minutes under the condition that the peripheral speed of the horizontal rotary blade was 8 m/sec, stirring was performed at 120° C. for 50 minutes and mechanical impact force (mechanochemical method) was applied to the core particles. A resin coating layer made of a coating resin was formed on the surface to prepare a carrier. 7 mass parts of each of the toners [1] to [6] were added to 93 mass parts of the carrier thus prepared, and the mixture was introduced into a V-type mixer and mixed to prepare developers [1] to [6].

### Evaluation

The photoreceptors [1] to [13] and the developers [1] to [6] produced as described above were combined as indicated in Table III below, and a commercially available color multifunction peripheral “bizhub PRO C6500” (made by Konica Minolta, Inc.) (hereinafter also referred to as an evaluation machine). Using this, in a normal temperature and humidity environment (temperature 20° C., humidity 50% RH), printing was performed to form a strip-shaped solid image having a printing rate of 5% on a high quality paper (65 g/m²) of A4 size as a test image. 1,000 sheets were printed. Next, in a high temperature and high humidity environment (temperature 30° C., humidity 80% RH), after performing 70,000 printings to form a strip-shaped solid image having a printing rate of 5% on a high-quality paper (65 g/m²) of A4 size, then printing of 30,000 sheets to form a belt-like solid image with a printing rate of 40% was performed. Next, a total of 100,000 sheets were printed in the same manner in a low temperature and low humidity environment (temperature 10° C., humidity 20% RH). After printing 1,000 sheets (indicated as Initial (NN) in Table IV), after printing 100,000 sheets (indicated as 100 kp (HH) in Table IV), and after printing 200,000 sheets (in Table IV, 200 kp (LL)), the following evaluations were made at each timing. The evaluation results are indicated in Table IV.

### (1) Charge Amount

A 400 mesh stainless steel screen is attached to the charge amount measuring device “Blow-off type TB-200” (manufactured by Toshiba). Under the condition of blow pressure 0.5 kgf/cm² (0.049 MPa), the toner in the developing unit after each printing was blown with nitrogen gas for 10 seconds. The charge amount (μC/g) was calculated by dividing the charge measured after the blow by the mass of the toner flying by the blow.

### (2) Image Density

At each timing described above, a solid patch was output on high-quality paper (65 g/m²) of A4 size, and the absolute image density was measured with a reflection densitometer RD-918 manufactured by Macbeth. The absolute image density is better as the amount of change from the initial stage (after the above-mentioned printing of 1,000 sheets) is smaller.

### (3) Fog

The absolute image density was measured with a Macbeth reflection densitometer “RD-918” at 20 locations on a high-quality paper 65 g/m²) of blank A4 size on which no image was formed, and the average value was defined as the blank paper density. Next, the absolute image density was measured in the same manner at 20 places in the white background portion of the evaluation image after printing 200,000 sheets, and the value obtained by subtracting the above white paper density from the average value was taken as the fog density. The calculated fog density was evaluated according to the following criteria. A case where the evaluation result was “AA” or “BB” was regarded as acceptable.

<Evaluation criteria>

AA: Fog density is 0.007 or less.

BB: Fog density is more than 0.007 and less than 0.011.

CC: Fog density is 0.011 or more.

### (4) Dot Reproducibility

As an image evaluation after printing 200,000 sheets, a gradation pattern with a gradation rate of 32 steps was output on high-quality paper (65 g/m²) of A4 size. The read value of this gradation pattern by a CCD (Coupled Charged Device) camera was subjected to a Fourier transform processing by taken into account of MTF (Modulation Transfer Function) correction. The GI (Graininess Index) value matched to the human specific visual sensitivity was measured to obtain the maximum GI value. The smaller the GI value, the better, and the smaller the GI value, the smaller the granularity of the image. In addition, this GI value is a value published in Journal of the Imaging Society of Japan 39 (2), 84/93 (2000). The determined maximum GI value was evaluated according to the following criteria. A case where the evaluation result was “AA” or “BB” was regarded as acceptable.

<Evaluation criteria>

AA: Maximum GI value is 0.170 or less.

BB: Maximum GI value is more than 0.170 and less than 0.180.

CC: Maximum GI value is 0.180 or more.

### (5) Photoreceptor Wear

Evaluation was made based on the amount of film thickness loss of the surface layer of the photoreceptor before and after the durability test. Specifically, the film thickness of the surface layer was measured by randomly measuring 10 portions of uniform thickness (excluding the coating thickness fluctuation portions at the front and rear ends of the coating by creating a thickness profile), and average value was the film thickness of the surface layer. As the film thickness measuring device, an eddy current type film thickness measuring device “EDDY560C” (HELMUT FISCHER GMBTE CO) was used, and the difference in the film thickness of the surface layer before and after the durability test was calculated as a film thickness depletion amount (μm).

<Evaluation criteria>

AA: Amount of wear≤0.6 μm (no problem in practical use)

BB: 0.6 μm<wear amount≤1.0 μm (no problem in practical use)

CC: Amount of wear>1.0 μm (practical problem)

### (6) Cleaning Blade Wear

After the durability test, the cleaning blade was observed with a shape measuring laser microscope “VK-X100” (manufactured by Keyence Corporation), and the wear width was calculated. The difference in wear width of the cleaning blade before and after the durability test was defined as the wear amount, and the wear amount was evaluated according to the following evaluation criteria. A wear amount of 20 μm or less was determined to be practical.

<Evaluation criteria>

AA: Wear width is 10 μm or less

BB: Wear width is greater than 10 μm and less than 20 μm

CC: Wear width is greater than 20 μm

### (7) Cleaning Property

After the above durability test, in an environment of 10° C. and 15% RH, 100 half-tone images were printed on A3 neutral paper so that the black background was located in the front of the paper transport direction and the white background was located in the rear. On the white background portion of the 100th print, the stain generated by the toner slipping was visually observed, and the cleaning property was evaluated according to the following evaluation criteria.

<Evaluation criteria>

AA: No dirt is seen on the white background

BB: A slight streak-like stain occurs on the white background, but there is no practical problem

CC: Clear streak-like stains occur on the white background (practical problem)

TABLE III

| | Photoreceptor | | | | | | | | | | |
|---|---|---|---|---|---|---|---|---|---|---|---|
| | | Surface-modified | | | | | Average | | | | |
| | | metal oxide particles | | | | | distance | | | | |
| | Pho- | Surface- | Unmodified metal | | | | R | Developer and Toner | | | |
| | to- | modified | oxide particles | | | | between | | | External additive | |
| | re- | metal | | avergae | | | the | | | metal oxide particles | |
| | cep- | oxide | | primary | | | convex | | | | average |
| | tor | particles | Type of | particle | Surface modification | | portions | Developer | Toner | | particle |
| | No. | No. | particles | size | Hydrophobic | Reactive | (nm) | No.. | No. | Type | size |
| Example 1 | 1 | P-1 | SnO₂ | 20 | KF9908(side chain) | S-16 | 100 | 1 | 1 | Alumina particles 1 | 20 |
| Example 2 | 2 | P-2 | SnO₂ | 50 | KF9908(side chain) | S-16 | 140 | 1 | 1 | Alumina particles 1 | 20 |
| Example 3 | 3 | P-3 | SnO₂ | 250 | KF9908(side chain) | S-16 | 240 | 1 | 1 | Alumina particles 1 | 20 |
| Example 4 | 4 | P-4 | BaSO₄/SnO₂ | 100 | n-Octyltrimethoxy- | S-16 | 170 | 1 | 1 | Alumina particles 1 | 20 |
| | | | Composite | | silane | | | | | | |
| | | | particles | | | | | | | | |
| Example 5 | 5 | P-5 | BaSO₄/SnO₂ | 100 | KF99(straight chain) | S-16 | 230 | 1 | 1 | Alumina particles 1 | 20 |
| | | | Composite | | | | | | | | |
| | | | particles | | | | | | | | |
| Example 6 | 6 | P-6 | BaSO₄/SnO₂ | 100 | KF574(side chain) | S-16 | 170 | 1 | 1 | Alumina particles 1 | 20 |
| | | | Composite | | | | | | | | |
| | | | particles | | | | | | | | |
| Example 7 | 7 | P-7 | BaSO₄/SnO₂ | 100 | KF9908(side chain) | S-16 | 160 | 1 | 1 | Alumina particles 1 | 20 |
| | | | Composite | | | | | | | | |
| | | | particles | | | | | | | | |
| Example 8 | 8 | P-8 | BaSO₄/SnO₂ | 100 | KF9909(side chain) | S-16 | 180 | 1 | 1 | Alumina particles 1 | 20 |
| | | | Composite | | | | | | | | |
| | | | particles | | | | | | | | |
| Example 9 | 9 | P-9 | BaSO₄/SnO₂ | 100 | KF9908(side chain) | No | 200 | 1 | 1 | Alumina particles 1 | 20 |
| | | | Composite | | | surface | | | | | |
| | | | particles | | | modi- | | | | | |
| | | | | | | fication | | | | | |
| Example | 7 | P-7 | BaSO₄/SnO₂ | 100 | KF9908(side chain) | S-16 | 160 | 2 | 2 | Alumina particles 1 | 5 |
| 10 | | | Composite | | | | | | | | |
| | | | particles | | | | | | | | |
| Example | 7 | P-7 | BaSO₄/SnO₂ | 100 | KF9908(side chain) | S-16 | 160 | 3 | 3 | Alumina particles 1 | 10 |
| 11 | | | Composite | | | | | | | | |
| | | | particles | | | | | | | | |
| Example | 7 | P-7 | BaSO₄/SnO₂ | 100 | KF9908(side chain) | S-16 | 160 | 4 | 4 | Alumina particles 1 | 60 |
| 12 | | | Composite | | | | | | | | |
| | | | particles | | | | | | | | |
| Example | 7 | P-7 | BaSO₄/SnO₂ | 100 | KF9908(side chain) | S-16 | 160 | 5 | 5 | Alumina particles 1 | 80 |
| 13 | | | Composite | | | | | | | | |
| | | | particles | | | | | | | | |
| Example | 10 | P-10 | BaSO₄/SnO₂ | 200 | KF9908(side chain) | S-16 | 230 | 1 | 1 | Alumina particles 1 | 20 |
| 14 | | | Composite | | | | | | | | |
| | | | particles | | | | | | | | |
| Com- | 7 | P-7 | BaSO₄/SnO₂ | 100 | KF9908(side chain) | S-16 | 160 | 6 | 6 | Titania particles | 25 |
| parative | | | Composite | | | | | | | | |
| example 1 | | | particles | | | | | | | | |
| Com- | 11 | P-11 | BaSO₄/SnO₂ | 100 | No surface | S-16 | 280 | 1 | 1 | Alumina particles 1 | 20 |
| parative | | | Composite | | modification | | | | | | |
| example 2 | | | particles | | | | | | | | |
| Com- | 12 | P-7 | BaSO₄/SnO₂ | 100 | KF9908(side chain) | S-16 | 260 | 1 | 1 | Alumina particles 1 | 20 |
| parative | | | Composite | | | | | | | | |
| example 3 | | | particles | | | | | | | | |
| Com- | 13 | P-1 | SnO₂ | 20 | KF9908(side chain) | S-16 | 80 | 1 | 1 | Alumina particles 1 | 20 |
| parative | | | | | | | | | | | |
| example 4 | | | | | | | | | | | |

TABLE IV

| | Charge amount | | | | | | | | | | |
|---|---|---|---|---|---|---|---|---|---|---|---|
| | Initial | 100 kp | 200 kp | Image density | | | | | | Cleaning | |
| | (NN) | (HH) | (LL) | Initial | 100 kp | 200 kp | | Dot | Photoreceptor | blade | Cleaning |
| | (μC/g) | [μC/g] | [μC/g] | (NN) | (HH) | (LL) | Fog | reproducibility | wear | wear | property |
| Example 1 | 51.0 | 42.1 | 53.0 | 1.28 | 1.31 | 1.27 | AA | AA | BB | BB | BB |
| Example 2 | 53.5 | 44.1 | 53.2 | 1.29 | 1.32 | 1.26 | AA | AA | AA | BB | BB |
| Example 3 | 51 | 42.3 | 52.6 | 1.30 | 1.29 | 1.26 | AA | BB | AA | BB | BB |
| Example 4 | 53.4 | 43.7 | 53.0 | 1.30 | 1.28 | 1.28 | AA | AA | BB | AA | BB |
| Example 5 | 49.0 | 42.1 | 53.8 | 1.29 | 1.33 | 1.27 | AA | AA | BB | BB | BB |
| Example 6 | 48.5 | 41.5 | 54.0 | 1.27 | 1.30 | 1.25 | AA | AA | AA | AA | AA |
| Example 7 | 49.6 | 41.8 | 52.6 | 1.29 | 1.33 | 1.27 | AA | AA | AA | AA | AA |
| Example 8 | 48.1 | 43.0 | 54.3 | 1.28 | 1.31 | 1.27 | AA | AA | AA | AA | AA |
| Example 9 | 48.5 | 41.5 | 51.5 | 1.30 | 1.33 | 1.25 | AA | AA | AA | AA | AA |
| Example 10 | 53.7 | 46.1 | 57.8 | 1.29 | 1.27 | 1.19 | BB | BB | AA | AA | AA |
| Example 11 | 49.6 | 41.8 | 52.6 | 1.28 | 1.31 | 1.25 | AA | AA | AA | AA | AA |
| Example 12 | 46.6 | 40.8 | 52.2 | 1.31 | 1.35 | 1.33 | AA | AA | AA | AA | AA |
| Example 13 | 44.1 | 37.2 | 48.1 | 1.30 | 1.39 | 1.44 | BB | BB | BB | BB | AA |
| Example 14 | 50.1 | 42.9 | 53.4 | 1.29 | 1.30 | 1.32 | AA | BB | AA | BB | AA |
| Comparative | 41.9 | 25.3 | 42.5 | 1.28 | 1.50 | 1.52 | CC | CC | AA | AA | AA |
| Example 1 | | | | | | | | | | | |
| Comparative | 48.6 | 39.5 | 52.2 | 1.31 | 1.36 | 1.33 | AA | BB | CC | CC | CC |
| Example 2 | | | | | | | | | | | |
| Comparative | 49.0 | 41.8 | 53.2 | 1.27 | 1.30 | 1.25 | AA | AA | CC | CC | CC |
| Example 3 | | | | | | | | | | | |
| Comparative | 50.2 | 40.9 | 54.1 | 1.28 | 1.30 | 1.25 | AA | AA | CC | BB | CC |
| Example 4 | | | | | | | | | | | |

As is clear from the above results, when the combination of the photoreceptor and the developer as in Examples 1 to 14 was compared with the case of the combination of the photoreceptor and the developer as in Comparative Examples 1 to 4, it was found that the variation in the charge amount is suppressed, the image density is stabilized, the occurrence of fog is suppressed, the dot reproducibility is excellent, the photoreceptor wear and the cleaning blade wear are small, and the cleaning property is also good.

Although the embodiments of the present invention have been described and illustrated in detail, the disclosed embodiments are made for purpose of illustration and example only and not limitation. The scope of the present invention should be interpreted by terms of the appended claims

What is claimed is:

1. An electrophotographic image forming method comprising: a charging step, an exposure step, a developing step, a transfer step and a cleaning step by using a photoreceptor,
wherein the charging step has a charging device for charging the surface of the photoreceptor; the photoreceptor has a protective layer, the protective layer contains a polymerized cured product of a composition containing a polymerizable monomer and an inorganic filler, a surface of the protective layer has a plurality of convex portions due to protrusion of the inorganic filler; in the developing step, a toner in which alumina particles are externally added to toner mother particles is used, and an average distance R between adjacent convex portions among the plurality of convex portions is set in the range of 100 to 250 nm.

2. The electrophotographic image forming method described in claim 1,
wherein the inorganic filler is surface modified with a surface modifier having a silicone chain in a side chain of the surface modifier.

3. The electrophotographic image forming method described in claim 1,
wherein the inorganic filler has a number average primary particle size in the range of 50 to 200 nm.

4. The electrophotographic image forming method described in claim 1,
wherein the alumina particles have a number average primary particle size in the range of 10 to 60 nm.

5. The electrophotographic image forming method described in claim 1,
wherein the inorganic filler has a polymerizable group.

6. The electrophotographic image forming method described in claim 1,
wherein the inorganic filler contains a composite particle of a core-shell structure having an outer shell in which a metal oxide is attached to a surface of a core material.
